(19) United States
(12) Patent Application Publication
(10) Pub. No.: US 2007/0021080 A1
(43) Pub. Date: Jan. 25, 2007

(54) Wireless communication device and mobile phone terminal using the same

(75) Inventors: Akira Kuriyama, Kokubunji (JP); Satoshi Tanaka, Kokubunji (JP); Tatemi Ido, Kodaira (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/480,371

(22) Filed: Jul. 5, 2006

(30) Foreign Application Priority Data
Jul. 8, 2005 (JP) 2005-200023

(51) Int. Cl. H04B 7/08; H04B 1/06; H04B 7/00

(52) U.S. Cl. 455/132; 455/272

(57) ABSTRACT

A multi-band multi-mode wireless communication device comprises a first antenna, a second antenna, a first transmitter circuit corresponding to the FDD system, a first receiver circuit and a second receiver circuit, a first transmitter circuit and a third receiver circuit corresponding to the TDD system, a duplexer, an SP3T switch, and a base-band signal processor. The second transmitter circuit, third receiver circuit and duplexer are connected with each other via the first antenna and the SP3T switch, the duplexer is connected to the first transmitter circuit and the first receiver circuit, and the second antenna is connected to the second receiver circuit. The received signals corresponding to the FDD system received by the first and second antennas are inputted to the base-band signal processor via the first and second receiver circuits and are then synthesized therein.

### CLAIM OF PRIORITY

The present application claims priority from Japanese application JP 2005-200023 filed on Jul. 8, 2005, the content of which is hereby incorporated by reference into this application.

### FIELD OF THE INVENTION

The present invention relates to a mobile wireless communication device represented by a cellular phone terminal and a PDA (Personal Digital Assistance) and particularly to a multi-band multi-mode wireless communication device and a cellular phone terminal corresponding to multi-band and plural communication systems for plural frequencies in radio frequency circuit devices.

### BACKGROUND OF THE INVENTION

The diversity receiving technology has been conventionally employed into an example of the multi-mode cellular phone terminals (for example, refer to the paragraphs 0020 to 0023 and FIG. 5 in Japanese Patent Laid-Open No. 2000-13274).

### SUMMARY OF THE INVENTION

A plurality of communication systems have been employed into mobile communication represented by a cellular phone system.

For example, in Europe, the W-CDMA (Wide-band Code Division Multiple Access) has been introduced as the third generation wireless communication system which has started to provide services in recent years, in addition to the GSM (Global System for Mobile Communication) which is already widespread as the second generation wireless communication system. Moreover, in North America, the cdma 2000-1× (Code Division Multiple Access 2000-1×) is widespread as the third generation wireless communication system in addition to the GSM as the second generation wireless communication system.

Moreover, for high speed transmission of a large amount of data such as stationary images and dynamic images, the EDGE (Enhanced Data Rate for GSM Evolution), HSDPA (High Speed Downlink Packet Access), cdma 2000-1×EV-DO (Code Division Multiple Access 2000-1×Evolution-Data Only) systems have also been proposed corresponding to the GSM, W-CDMA, cdma 2000-1×, etc.

Of these communication systems, the GSM is the time division multiplex communication system, namely the time division duplex (TDD) system utilizing the GMSK (Gaussian filtered Minimum Shift Keying) modulation. The W-CDMA and cdma 2000-1× are the frequency division multiplex communication system, namely the frequency division duplex (FDD) system utilizing the QPSK (Quadrature Phase Shift Keying) modulation. Therefore, structures of frequency modulator/demodulator and antenna peripheral circuits are considerably different in communication circuit for GSM and communication circuit for W-CDMA or cdma 2000-1×.

Moreover, it is required to improve receiver sensitivity of terminals in order to increase data transmission capacity of the down-link (communication to terminals from a base station) in the HSDPA and cdma 2000-1×, EV-DO. Diversity receiving has been proposed as the technology to improve receiver sensitivity. The diversity receiving has been proposed as the technology to improve receiver sensitivity by synthesizing the received signal of each receiver in the base-band signal process using two antennas and two receivers connected to each antenna.

Therefore, the cellular phone terminals corresponding to the GSM, W-CDMA, cdma 2000-1×, EDGE, HSDPA, cdma 2000-1×EV-DO explained above require the diversity antennas and receiver circuits, in addition to the cellular phone terminals corresponding to the GSM, W-CDMA, cdma 2000-1×, EDGE explained above.

An example disclosed in the Japanese Patent Laid-Open No. 2000-13274 shows a structure of radio frequency circuit unit of a dual mode cellular phone terminal of the W-CDMA/PDC (Personal Digital Cellular System). In the Japanese Patent Laid-Open No. 2000-13274, the reference numerals and a part of the structure in FIG. 5 are not explained but each reference numeral can be interpreted as follows from the explanation thereof. The reference numerals 110, 115 and 117 denote antennas, 111, 113 denote switches, and 118 denotes a duplexer, 136 denotes a transmitter circuit for PDC, 112 denotes a receiver circuit for PDC, 135 denotes a transmitter circuit for W-CDMA, 114 denotes a receiver circuit for W-CDMA, and 116 denotes a receiver circuit.

Therefore, a circuit structure of FIG. 5 may be interpreted as follows. The transmitter circuit for PDC 136 is connected with the antenna 117 via the switches 113 and 114, while the receiver circuit for PDC 112 is connected with the antenna 110 via the switch 111 or connected with the antenna 117 via the switches 111, 113, and 134 to realize a transmitter/receiver for PDC. Meanwhile, the transmitter circuit for W-CDMA 135 is connected with the antenna 117 via the duplexer 118 and switch 134, while the receiver circuit for W-CDMA 114 is connected with the antenna 117 via the duplexer 118 and the switch 134 to realize the transmitter/receiver for W-CDMA. Moreover, since FIG. 5 shows a structure of the radio frequency circuit unit of the dual mode cellular phone terminal of W-CDMA/PDC, the receiver circuit 116 may be interpreted to have the function of the diversity receiver circuit for W-CDMA. In addition, the antenna 115 connected only to the receiver circuit 116 may also be interpreted to have the function of the diversity antenna for W-CDMA.

However, the technology disclosed in the Japanese Patent Laid-Open No. 2000-13274 has been accompanied with a problem that reduction in size of a terminal is difficult because three antennas in total are required as the antenna for W-CDMA diversity, in addition to the antennas for W-CDMA and PDC.

It is therefore an object of the present invention to provide a multi-band multi-mode wireless communication device which may be reduced in size.

It is another object of the present invention to provide a multi-band multi-mode wireless communication device which may be reduced in power consumption.

It is another object of the present invention to provide a multi-band multi-mode wireless communication device which may be reduced in size and power consumption corresponding to a high-speed large-capacity communication system.

The aforementioned and the other objects and novel features of the present invention will become apparent from the description of the present specification and the accompanying drawings thereof.

Summary of the typical inventions among those disclosed in the present application will be explained briefly as follows.

The wireless communication device of the present invention is a wireless communication device provided with a diversity antenna comprising a first receiver circuit for inputting the received signal received with a first antenna, corresponding to the frequency division duplex system, a second receiver circuit for inputting the received signal received with a second antenna different from the first antenna, corresponding to the frequency division duplex system, and a local oscillator for supplying in common the local frequency to the first and second receiver circuits and is constituted to obtain the received signal by synthesizing the received signal received with the first antenna and the received signal received with the second antenna. Moreover, the wireless communication device of the present invention is characterized in that the first and second receiver circuits and the local oscillator are formed in the same semiconductor device.

According to the present invention, there is provided a multi-band multi-mode wireless communication device which may be reduced in size.

### BRIEF DESCRIPTION OF THE DRAWINGS

FIG. 1A is a circuit diagram of a multi-band multi-mode wireless communication device as the first embodiment of the present invention.

FIG. 1B is a diagram showing a structure of a base-band signal processor in the wireless communication device of FIG. 1A.

FIG. 2A is a circuit diagram of a multi-band multi-mode wireless communication device as the second embodiment of the present invention.

FIG. 2B is a diagram for explaining operations of a switch control unit of a base-band signal processor in the wireless communication device of FIG. 2A.

FIG. 3A is a circuit diagram of a multi-band multi-mode wireless communication device as the third embodiment of the present invention.

FIG. 3B is a diagram for explaining operations of a switch control unit of a base-band signal processor in the wireless communication device of FIG. 3A.

FIG. 4A is a circuit diagram of a multi-band multi-mode wireless communication device as the fourth embodiment of the present invention.

FIG. 4B is a diagram for explaining operations of a switch control unit of a base-band signal processor in the wireless communication device of FIG. 4A.

FIG. 4C is a diagram for explaining operational effect of the wireless communication device of FIG. 4A.

FIG. 5A is a circuit diagram of a multi-band multi-mode wireless communication device as the fifth embodiment of the present invention.

FIG. 5B is a diagram for explaining operations of a switch control unit of a base-band signal processor in the wireless communication device of FIG. 5A.

FIG. 6 is a circuit diagram of a multi-band multi-mode wireless communication device as the sixth embodiment of the present invention.

FIG. 7 is a circuit diagram of a multi-band multi-mode wireless communication device as the seventh embodiment of the present invention.

FIG. 8 is a circuit diagram of a multi-band multi-mode wireless communication device as the eighth embodiment of the present invention.

FIG. 9 is a circuit diagram of a multi-band multi-mode wireless communication device as the ninth embodiment of the present invention.

FIG. 10 is a circuit diagram of a multi-band multi-mode wireless communication device as the tenth embodiment of the present invention.

FIG. 11 is a circuit diagram of a multi-band multi-mode wireless communication device as the eleventh embodiment of the present invention.

FIG. 12 is a circuit diagram of receiver system of a multi-band multi-mode wireless communication device as the twelfth embodiment of the present invention.

FIG. 13 is a diagram showing a module profile of a multi-band multi-mode wireless communication device as the thirteenth embodiment of the present invention.

FIG. 14 is a diagram showing a module profile of a multi-band multi-mode wireless communication device as the fourteenth embodiment of the present invention.

FIG. 15 is a diagram showing a module profile of a multi-band multi-mode wireless communication device as the fifteenth embodiment of the present invention.

FIG. 16 is a diagram showing modification examples of a peripheral circuit in each embodiment of the present invention.

### DETAILED DESCRIPTION OF THE PREFERRED EMBODIMENTS

The preferred embodiments of the present invention will be explained in detail with reference to the accompanying drawings. The same elements having the same or similar functions are denoted with the same reference numerals throughout the drawings and the same elements will not be explained repeatedly.

A multi-band multi-mode wireless communication device of the present invention which will be explained below corresponds to a high speed and large capacity communication system of at least 1 Mbps or more such as HSDPA, cdma 2000-1×EV-DO, etc.

Moreover, an example of a cellular phone terminal is considered as a circuit provided with the multi-band multi-mode wireless communication device explained above in order to realize a simplified structure to explain structure, operations and effects of the multi-band multi-mode wireless communication device of the present invention.

First of all, as the first to the fourth embodiments, a cellular phone terminal corresponding to the single band W-CDMA of the FDD system (transmitted frequency: 1920 to 1980 MHz; received frequency: 2110 to 2170 MHz) or a cellular phone terminal corresponding to this single band W-CDMA and the single band GSM of the TDD system (transmitted frequency: 1850 to 1910 MHz; received frequency: 1930 to 1990 MHz) will be explained.

### First Embodiment

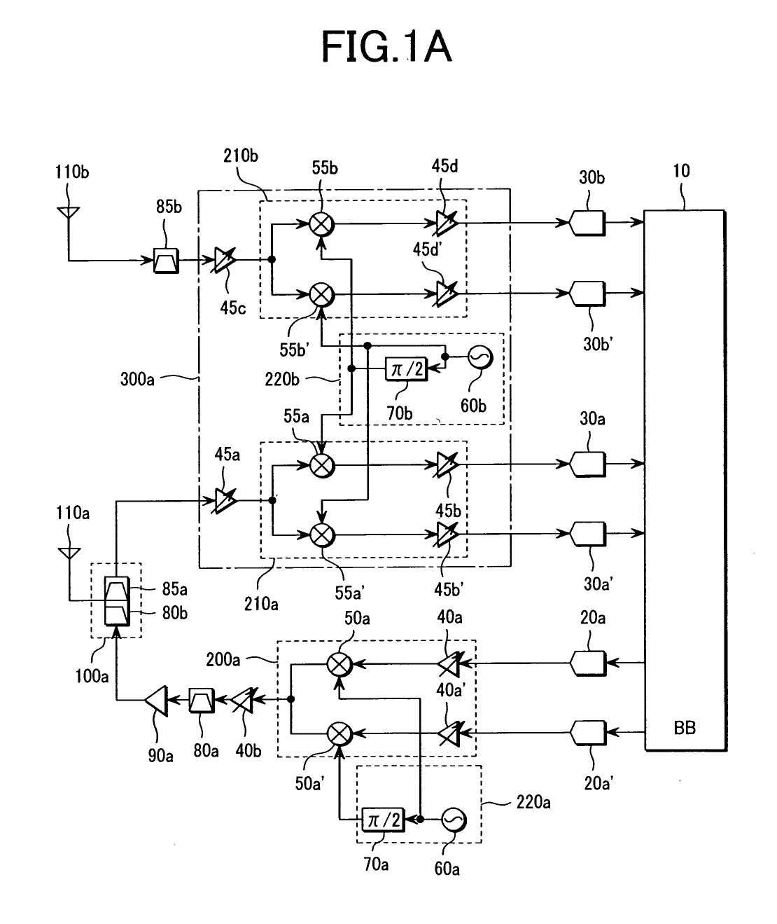

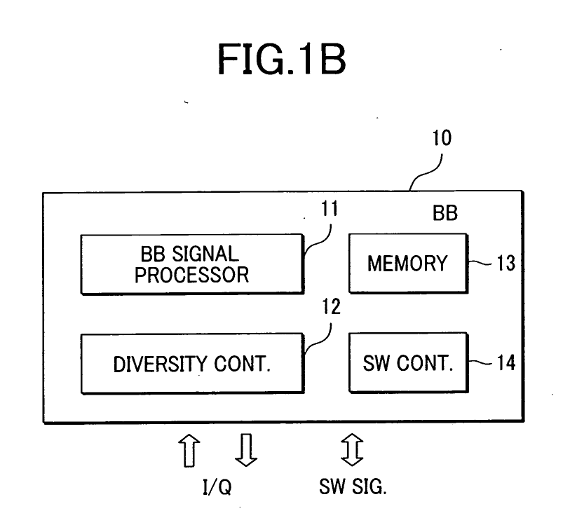

FIG. 1A is a circuit diagram showing a cellular phone terminal provided with a multi-band multi-mode wireless communication device corresponding to W-CDMA as the first embodiment of the present invention.

The multi-band multi-mode wireless communication device of the embodiment shown in FIG. 1A comprises a first transmitter circuit of the FDD system corresponding to the radio communication system explained above, a first receiver circuit and a second receiver circuit of the FDD system, a local oscillator for supplying local frequency to the first and second receiver circuits, and a first antenna and a second antenna. The first transmitter circuit corresponding to the first antenna 110a includes a modulator 200a, and the first receiver circuit corresponding to the first antenna 110a includes a variable gain amplifier 45a and a demodulator 210a. The second receiver circuit corresponding to the second antenna 110b includes a variable gain amplifier 45c and a demodulator 210b. The first and second receiver circuits and a local oscillator 220b for supplying local frequency to these receiver circuits are formed in the same semiconductor device 300a.

To explain in more detail, in FIG. 1A, numeral 10 denotes a base-band signal processor; 20a and 20a′are digital/analog converters (D/A converters); 30a to 30b′are analog digital converters (A/D converters). 40a to 40b denote variable gain amplifiers; 45a to 45d′are variable gain amplifiers; 50a to 50a′ and 55a to 55b are mixers; 60a and 60b are oscillators; 70a and 70b are phase shifters; 80a to 80b and 85a to 85b are filters; 90a is power amplifier; 110a, 110b are first and second antennas.

100a denotes a duplexer mainly constituted with filters 80b and 85a. 200a denotes a modulator mainly constituted with variable gain amplifiers 40a to 40a′ and mixers 50a to 50a′. 210a denotes a demodulator mainly constituted with mixers 55a to 55a′ and variable gain amplifiers 45b to 45b′. 210b denotes a demodulator mainly constituted with mixers 55b to 55b′ and variable gain amplifiers 45d to 45d′. 220a denotes a local oscillator mainly constituted with an oscillator 60a and a phase shifter 70a. 220b denotes a local oscillator mainly constituted with an oscillator 60b and a phase shifter 70b. A semiconductor device 300a mainly includes variable gain amplifiers 45a to 45c, demodulators 210a to 210b and the local oscillator 220b.

FIG. 1B is a block diagram showing a structure of the base band signal processor of FIG. 1A. The base band signal processor 10 comprises a base band signal processor 11 for processing RF signals, a diversity control unit 12, and a memory 13 or the like.

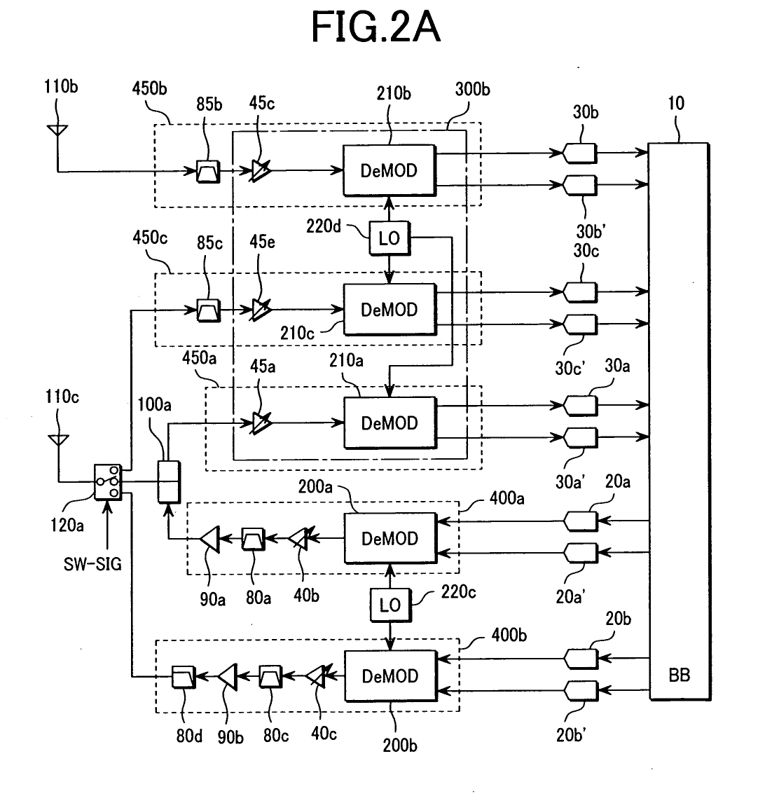

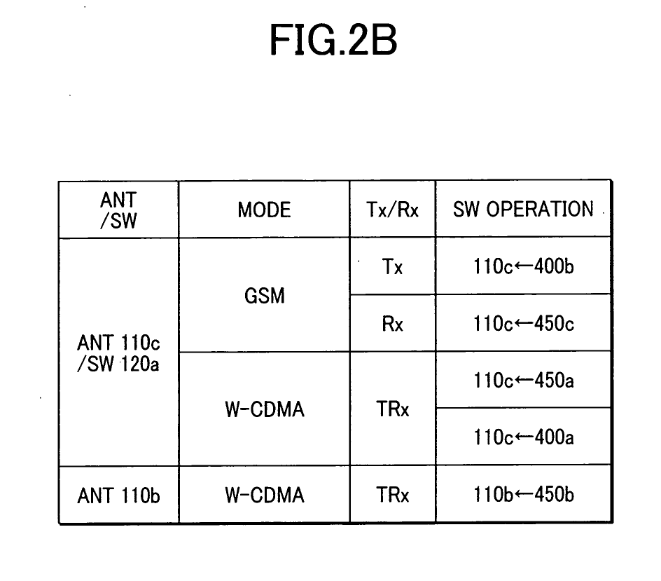

The diversity control unit 12 has the function to compensate for phase and intensity of the signals and also synthesize signals. The reference numeral 14 denotes a switch control unit corresponding to the embodiments explained with reference to FIG. 2 and the subsequent drawings.

Next, operations of the multi-band multi-mode wireless communication device as the first embodiment of the present invention will be explained with reference to FIG. 1A and FIG. 1B.

Of the transmitted digital I/Q signal outputted from the base-band signal processor 10, the I signal is converted to the transmitted analog I signal in the D/A converter 20a, amplified with the variable gain amplifier 40a, and is then inputted to the mixer 50a. Of the transmitted digital I/Q signal outputted from the base-band signal processor 10, the Q signal is also converted to the transmitted analog Q signal in the D/A converter 20a′, amplified in the variable gain amplifier 40a′ and is then inputted to the mixer 50a′. The oscillator 60a connected to the mixers 50a and 50a′ is the oscillator to generate the transmitted frequency, and the phase shifter 70a is inserted between the mixer 50a′ and the oscillator 60a to give difference in phase of 90 degrees in the I/Q signal in the mixers 50a and 50a′. The transmitted analog I signal frequency-converted to the transmitted frequency in the mixer 50a and the transmitted analog Q signal frequency-converted to the transmitted frequency in the mixer 50a′ are synthesized and thereafter inputted to the variable gain amplifier 40b as the transmitted signal, inputted to the power amplifier 90a via the filter 80a, amplified up to the transmitted power in the power amplifier 90a, and then transmitted from the first antenna 110a via a duplexer 100a. The modulation system explained above is called in general as direct up-conversion.

Meanwhile, the received signal received by the first antenna 110a is inputted to the variable gain amplifier 45a via a duplexer 100a and is then amplified therein. The received signal outputted from the variable gain amplifier is then divided to two signals and are then inputted into two mixers 55a and 55a′. An oscillator 60b connected with the mixers 55a and 55a′ oscillates the received frequency, and a phase shifter 70b is inserted between the mixer 55a′ and the oscillator 60b to give phase difference of 90 degrees to the I/Q signal in the mixers 55a and 55a′. The received signal inputted to the mixer 55a is frequency-converted to the base-band frequency, amplified with the variable gain amplifier 45b as the received analog I signal, thereafter converted to the received digital I signal with the A/D converter 30a, and inputted to the base-band signal processor 10. Meanwhile, the received signal inputted to the mixer 55a′ is frequency-converted to the base-band frequency, amplified with the variable gain amplifier 45b′ as the received analog Q signal, thereafter converted to the received digital Q signal with the A/D converter 30a′ and then inputted to the base-band signal processor 10. The demodulating system explained above is called in general as direct down-conversion.

Moreover, the received signal received by the second antenna 110b is then inputted to the base-band signal processor 10 as the received digital I/Q signal with the circuit operation similar to that for the received signal received by the first antenna 110a.

Since the first received digital I/Q signal inputted via the A/D converters 30a and 30a′ and the second received digital I/Q signal inputted via the A/D converters 30b and 30b′ are a little different from each other in phase and sensitivity depending on arrangement and sensitivity of the first and second antennas 110a, 110b, these signals are synthesized after compensation for phase and intensity by the base-band signal processor 10. Therefore, when the first and second received digital I/Q signals are identical in phase and intensity, receiver sensitivity is doubled theoretically. This operation is called in general, diversity receiving.

Accordingly, the multi-band multi-mode wireless communication device as the first embodiment of the present invention of FIG. 1A comprises another receiver circuit in addition to a pair of transmitter/receiver circuits for a pair of W-CDMAs and is constituted to synthesize the first and second received digital I/Q signals in the base-band signal processor 10.

According to the multi-band multi-mode wireless communication device as the first embodiment of the present invention of FIG. 1A, one local oscillator 220b is used as the oscillator for both demodulators 210a and 210b. The local oscillator 220b is formed in the same semiconductor device 300a with the demodulators 210a and 210b, for example, by the CMOS process or BiCMOS process.

The multi-band multi-mode wireless communication device as the first embodiment of the present invention of FIG. 1A provides following effects.

According to the first embodiment of the present invention, the local oscillator is provided in common to supply the local frequency to the demodulators of the first and second receiver circuits for W-CDMA. Moreover, areas of circuit or semiconductor device can be reduced by forming at least the first and second demodulators and local oscillator on the same semiconductor device.

Moreover, fluctuation in manufacture of circuits can be eliminated and operation characteristics of circuits can be matched with each other by mounting the demodulators and local oscillators of the first and second receiver circuits on the same semiconductor device with the CMOS process or the like. As a result, mismatching in operation of the local oscillator for the first and second demodulators can be eliminated and thereby the multi-band multi-mode wireless communication device ensuring higher control accuracy can be provided.

Moreover, it is also possible to provide the multi-band multi-mode wireless communication device for realizing reduction in size and power consumption in accordance with the high speed and large capacity communication system.

### Second Embodiment

Next, the multi-band multi-mode wireless communication device as the second embodiment of the present invention will be explained with reference to FIG. 2A and FIG. 2B. FIG. 2A is a circuit diagram showing a structure of the device as a whole and FIG. 2B is a diagram for explaining operations of a switch control unit of the base-band signal processor 10.

As shown in FIG. 2A, this multi-band multi-mode wireless communication device comprises the second antenna 110b, a third antenna 110c, a first transmitter circuit 400a and a first receiver circuit 450a corresponding to the FDD system, a second receiver circuit 450b corresponding to the FDD system, a second transmitter circuit 400b and a third receiver circuit 450c corresponding to the TDD system, a duplexer 100a, a first switch 120a of SP3T (single-pole triple throw), and a base-band signal processor 10. The first transmitter circuit 400a, a third receiver circuit 450c and the duplexer 100a are respectively connected via the third antenna 110c and the first switch 120a of SP3T, the duplexer 100a is connected with the first transmitter circuit 400a and the first receiver circuit 450a and the second antenna 110b is connected with the second receiver circuit 450b.

The switch control unit 14 of FIG. 1B generates the switch change-over control signal (SW-sig.) corresponding to usage condition of the wireless communication device, for example, cellular phone terminal in order to change over the connecting condition of the first switch 120a, antenna, and transmitter/receiver circuit.

The received signals corresponding to the FDD system received by the second and third antennas 110b, 110c are inputted to the base-band signal processor 10 via the first and second receiver circuits 450a, 450b and are synthesized after compensation for phase and intensity by the diversity control unit 17. Accordingly, a wireless communication circuit corresponding to the FDD system having the diversity receiving function and a wireless communication circuit corresponding to the TDD system are obtained with two antennas.

In more detail, in FIG. 2A, 20b to 20b′ denote D/A converters; 30c to 30c′ are A/D converters; 40c is a variable gain amplifier; 45e is a variable gain amplifier; 80c to 80d and 85c are filters; 90b is a power amplifier; 110c is a third antenna; 120a is a first switch; 200b is a modulator; 210c is a demodulator; 300b is a semiconductor device.

400a denotes a first transmitter circuit block mainly comprising a modulator 200a, a variable gain amplifier 40b, a filter 80a and a power amplifier 90a. 400b denotes a second transmitter circuit block mainly comprising the modulator 200b, the variable gain amplifier 40c, the filter 80c, a power amplifier 90a, and the filter 80d. 450a denotes a first receiver circuit block mainly comprising a variable gain amplifier 45a and a demodulator 210a. 450b denotes a second receiver circuit block mainly comprising the variable gain amplifier 45c and the demodulator 210b. 450c denotes a third receiving circuit block mainly comprising the filter 85c, the variable gain amplifier 45e and the demodulator 210c.

Next, operations of the multi-band multi-mode wireless communication device will be explained with reference to the state of switch change-over control in FIG. 2B.

The transmitted digital I/Q signals corresponding to W-CDMA outputted from the base-band signal processor 10 are transmitted from the third antenna 110c as the transmitted signal through the processes similar to the operations in the first embodiment of FIG. 1A. However, the embodiment of FIG. 2A is different from the embodiment of FIG. 1A in the structure that the switch 120a of SP3T is inserted between the duplexer 100a and the third antenna 110c.

Moreover, the received signal corresponding to W-CDMA received by the third antenna 110c is inputted to the base-band signal processor 10 as the first received digital I/Q signal through the processes similar to the operations of FIG. 1A. However, FIG. 2A is different from FIG. 1A in the structure that the first switch 120a of SP3T is inserted between the duplexer 100a and the third antenna 110c.

For the operations in W-CDMA, the first switch 120a of SP3T is connected to the terminal connected to the duplexer 100a.

In addition, the received signal corresponding to W-CDMA received by the second antenna 110b is inputted to the base-band signal processor 10 as the second received digital I/Q signal through the processes similar to the operations of FIG. 1A.

The first and second received digital I/Q signals are synthesized in the base-band signal processor 10 after compensation for phase and intensity.

On the other hand, the transmitted digital I/Q signal corresponding to GSM outputted from the base-band signal processor 10 is then inputted to the modulator 200b through conversion into the transmitted analog I/Q signal by the D/A converters 20b and 20b′. The signal is then frequency-converted into the transmitted frequency by the modulator 200b, inputted to the power amplifier 90b as the transmitted signal via the variable gain amplifier 40c and filter 80c, amplified up to the transmitted power by the power amplifier 90b, and then transmitted from the third antenna 110c via the filter 80b and the first switch 120a.

Moreover, the received signal corresponding to GSM received by the third antenna 110c is inputted to the variable gain amplifier 45e through the filter 85c and is then amplified therein. Thereafter, the received signal is frequency-converted to the base-band frequency by the demodulator 210c and is then inputted to the base-band signal processor 10 via the A/D converters 30c and 30c′ as the received analog I/Q signals which are orthogonal with each other (resulting in phase difference of 90 degrees).

In the case of GSM operation, the first switch 120a is connected to the terminal connected to the filter 80d in the transmitting condition, while the first switch 120a is connected to the terminal connected to the filter 85c in the receiving condition.

The first local oscillator (LO) 220c operates as a variable frequency oscillator for oscillating the transmitted frequency of GSM and W-CDMA. The second local oscillator (LO) 220d operates as a variable frequency oscillator for oscillating the received frequency of GSM and W-CDMA. Since this local oscillator 220d is used as the oscillator for both demodulators 210a to 210c, it is formed in the same semiconductor device 300b, for example, with the CMOS process or BiCMOS process.

Accordingly, as shown in FIG. 2B, the multi-band multi-mode wireless communication device of this second embodiment has the function to operate any of the first transmitter circuit block 400a for W-CDMA, first receiver circuit block 450a for W-CDMA, second receiver circuit block 450b for W-CDMA, second transmitter circuit block 400b for GSM and the third receiver circuit block 450c for GSM.

Namely, the second embodiment has the W-CDMA diversity receiving function and the wireless communication circuit corresponding to the FDD system and the wireless communication circuit corresponding to the TDD system are obtained with two antennas and only one switch.

The multi-band multi-mode wireless communication device as the second embodiment of the present invention of FIG. 2A is capable of providing the following effects.

Reduction in size can be obtained in comparison with the cellular phone terminal conventionally requiring three antennas by comprising the first transmitter circuit block 400a, first and second receiver circuit blocks 450a, 450b for W-CDMA, and second transmitter circuit block 400b and third receiver circuit block 450c for GSM and realizing the cellular phone terminal corresponding to the diversity receiving with use of two of the second and third antennas 110b, 110c in the W-CDMA.

Moreover, area of circuit or semiconductor device can also be reduced by providing in common the first and second receiver circuit blocks 450a, 450b for W-CDMA and the second local oscillator 220d for supplying the local frequency to the demodulator of the third receiver circuit block 450c for GSM and moreover mounting at least the demodulators 210a to 210c and the second local oscillator 220d on the same semiconductor device 300b.

In addition, the multi-band multi-mode wireless communication device for realizing reduction in size and power consumption can also be provided corresponding to the high-speed and large-capacity communication system.

### Third Embodiment

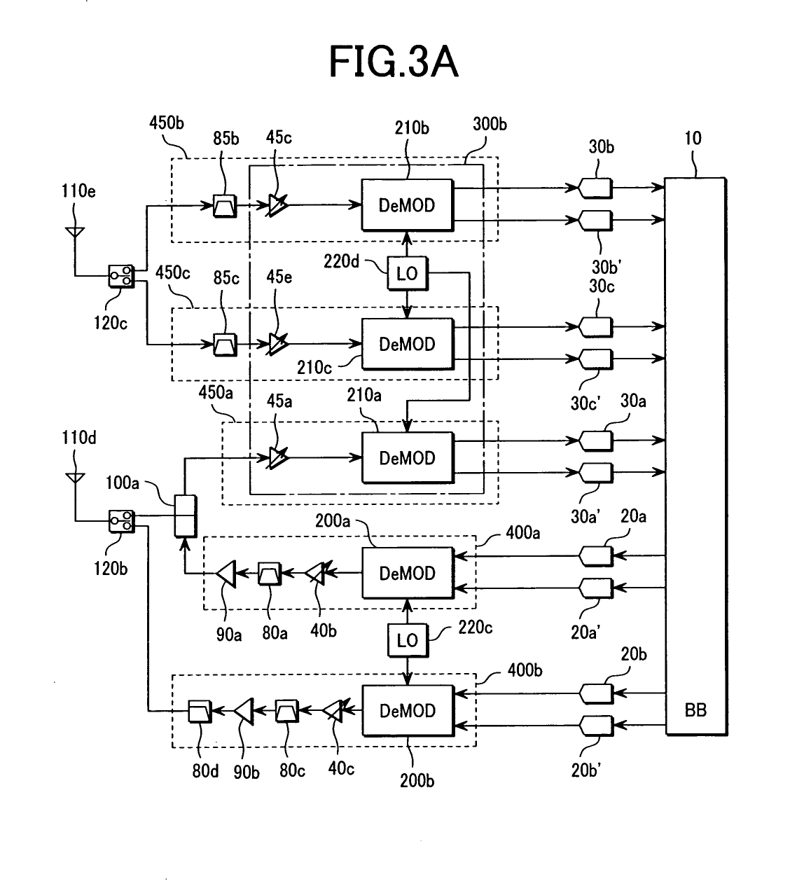

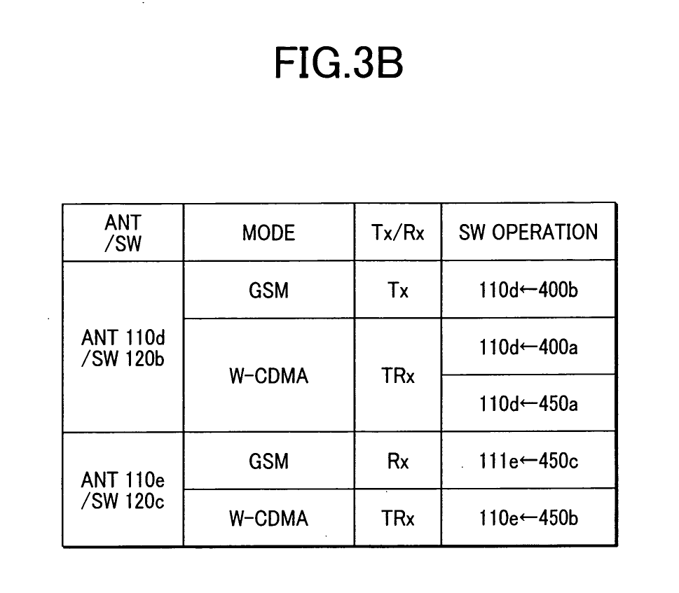

The third embodiment of the present invention will be explained with reference to FIG. 3A and FIG. 3B. FIG. 3A is a circuit diagram showing a radio frequency circuit unit of a cellular phone terminal as the third embodiment. The reference numerals in FIG. 3 and subsequent drawings which are same with numerals in FIGS. 1A and 2A denote the same elements in FIG. 1A and FIG. 2A. Therefore, the details of these elements are not explained below.

First, the multi-band multi-mode wireless communication device as the third embodiment of the present invention will be explained with reference to FIG. 3A.

In FIG. 3A, 110d, 110e denote a fourth antenna and a fifth antenna, while 120b, 120c denote a second switch and a third switch. This embodiment is different from the first and second embodiments explained above in the structure that the fourth antenna 110d is connected to the filter 80d and the duplexer 100a via the switch 120b, while the fifth antenna 110e is connected to the filters 85b and 85c via the switch 120c.

Operations of the multi-band multi-mode wireless communication device as the third embodiment of the present invention will be explained with reference to FIG. 3A and FIG. 3B.

The third embodiment is different from the second embodiment in that the structure in the case of W-CDMA operation, the second switch 120b is connected to the first transmitter circuit 400a and the first receiver circuit block 450a connected to the duplexer 100a, while the third switch 120c is connected to the terminal connected to the second receiver circuit block 450b, and in the case of GSM operation, the second switch 120b is connected to the second transmitter circuit block 400b connected to the filter 80d in the transmitting condition, while the third switch 120c is connected to the third receiver circuit block 450c connected to the filter 85c in the receiving condition.

Accordingly, the multi-band multi-mode wireless communication device of the third embodiment of the present invention has the function to selectively operate, by controlling the second switch 120b and the third switch 120c, the first transmitter circuit block 400a for W-CDMA, first receiver circuit block 450a for W-CDMA, second receiver circuit block 450b for W-CDMA, second transmitter circuit block 400 for GSM and the third receiver circuit block 450c for GSM as shown in FIG. 3B.

Namely, the wireless communication circuit corresponding to the FDD system and the wireless communication circuit corresponding to the TDD system having the W-CDMA diversity receiving function can be obtained with two antennas and two switches.

Moreover, the multi-band multi-mode wireless communication device shown in FIG. 3A can provide, like the first and second embodiments, the effect that area of circuit or semiconductor device can be reduced by mounting at least the variable gain amplifier, demodulator and local oscillator on one semiconductor device.

### Fourth Embodiment

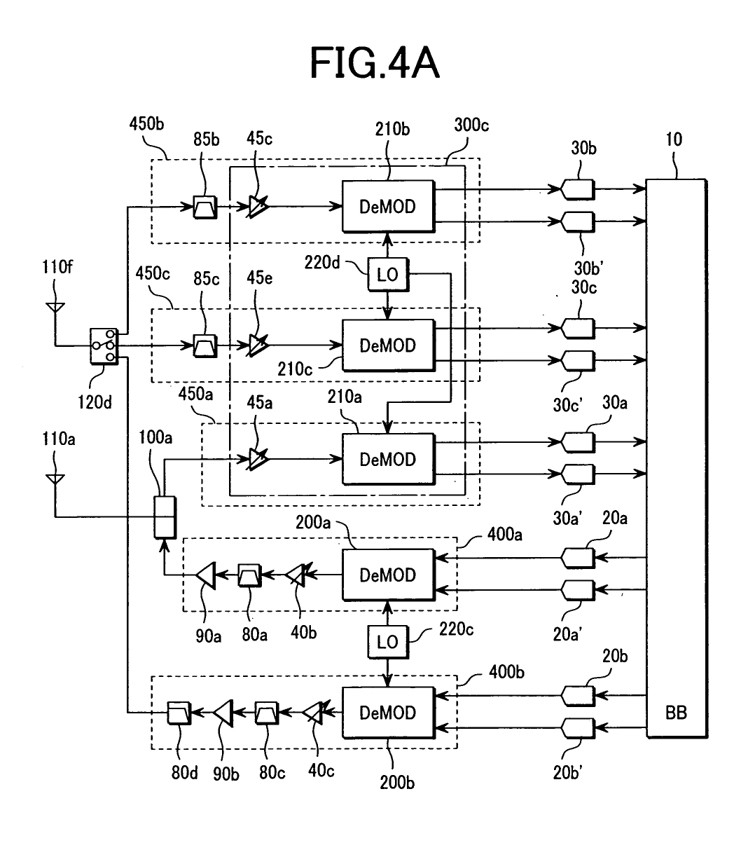

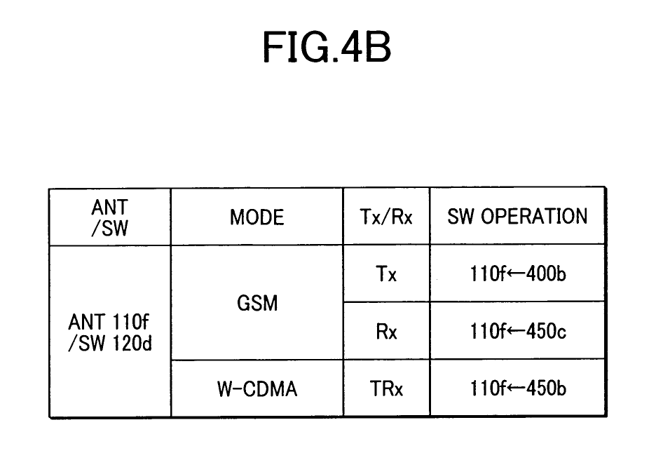

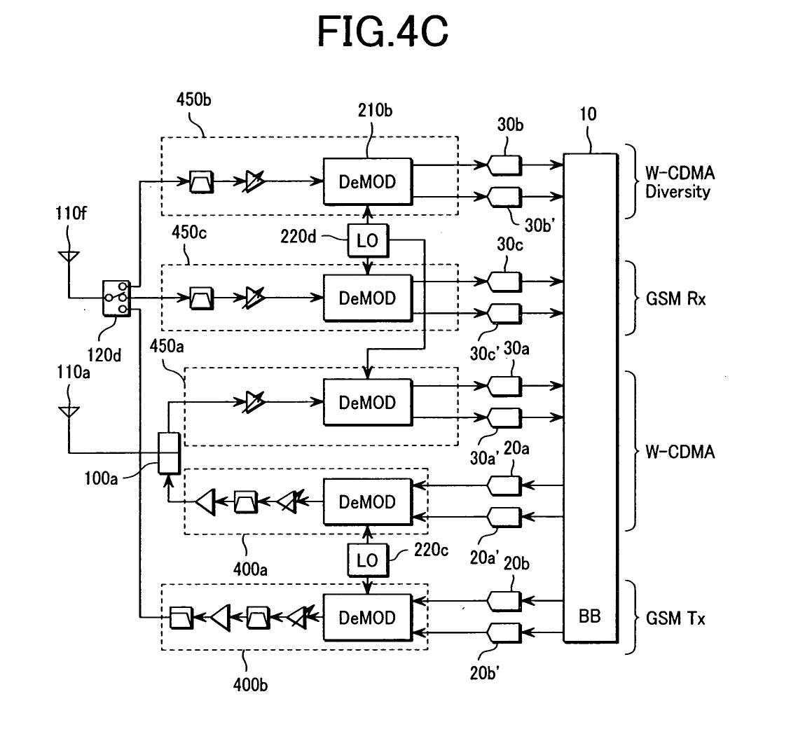

A structure of the multi-band multi-mode wireless communication device as the fourth embodiment of the present invention will be explained with reference to FIG. 4A, FIG. 4B and FIG. 4C.

FIG. 4A is a circuit diagram showing a radio frequency circuit unit of a cellular phone terminal. 110f denotes a sixth antenna and 120d denotes a fourth switch. The fourth embodiment is different from the second embodiment and the third embodiment in that the structure in the first antenna 110a is connected with the duplexer 100a, while the sixth antenna 110f is connected to the respective transmitter circuit block or receiver circuit block via the fourth switch 120d. Change-over state of the fourth switch 120d is controlled like the second and third embodiments with the switch control unit of the base-band signal processor 10 (similar switch control is also conducted in each embodiment explained later).

Next, operations of the multi-band multi-mode wireless communication device as the fourth embodiment of the present invention will be explained with reference to FIG. 4B.

In the case of W-CDMA operation, as shown in FIG. 4B, the fourth switch 120d is connected, by the switch control unit, to the terminal (Tx) connected to the second transmitter circuit block 400b for GSM in the transmitting condition in the case of GSM operation, and is connected to the terminal (Rx) connected to the third receiver circuit block 450c for GSM in the receiving condition. Moreover, in the case of W-CDMA operation, the fourth switch 120d is connected to the terminal connected to the second receiver circuit block 450b for W-CDMA.

Accordingly, the multi-band multi-mode wireless communication device of this fourth embodiment has the function, as shown in FIG. 4C, to selectively operate the first transmitter circuit block 400a for W-CDMA, the first receiver circuit block 450a for W-CDMA, second receiver circuit block 450b for W-CDMA, the second transmitter circuit block 400b for GSM, and the third receiver circuit block 450c for GSM. Namely, the wireless communication circuit corresponding to the FDD system and the wireless communication circuit corresponding to the TDD system having the W-CDMA diversity receiving function can be obtained with two antennas and one switch.

The multi-band multi-mode wireless communication device as the fourth embodiment of the present invention of FIG. 4A is capable of providing the following effects.

First, circuit loss for one switch can be reduced in comparison with the structure including the first and second switches 120a, 120b like the third embodiment explained above by providing only the duplexer 100a between the power amplifier 90a for amplifying the transmitted signal corresponding to W-CDMA up to the transmitted power and the first antenna 110a. Such circuit loss is different depending on structure and material of the switch but it is generally about 0.3 dB.

Therefore, when the transmitted powers from the antenna are identical in the multi-band multi-mode wireless communication device as the fourth embodiment of FIG. 4A, the transmitted power of the power amplifier 90a can be reduced as much as 0.3 dB and thereby power consumption of the power amplifier 90a can also be reduced.

Moreover, in view of allowing the transmitted signal corresponding to W-CDMA to pass, the first and second switches 120a, 120b are required to satisfy the dielectric strength corresponding to the transmitted power and linearity requested for W-CDMA in the second the third embodiments. Accordingly, circuit areas of the first and second switches 120a, 120b are increased. On the other hand, in the multi-band multi-mode wireless communication device as the fourth embodiment of FIG. 4A, circuit area of the third switch 120c can be reduced because the fourth switch 120d allows the received signal having very small power to pass for both W-CDMA and GSM operations. Therefore, circuit area can further be reduced in comparison with the second and third embodiments in the multi-band multi-mode wireless communication device as the fourth embodiment of FIG. 4A.

### Fifth Embodiment

In the first to fourth embodiments, a cellular phone terminal corresponding to the single band GSM and single band W-CDMA has been explained as an example.

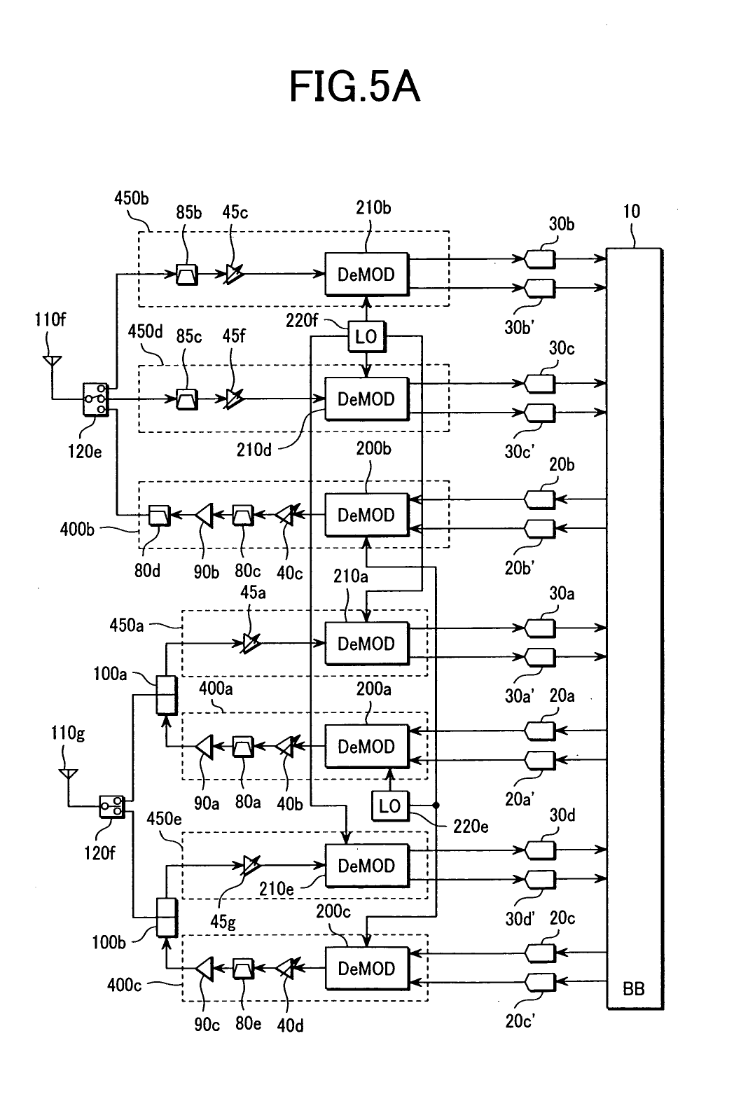

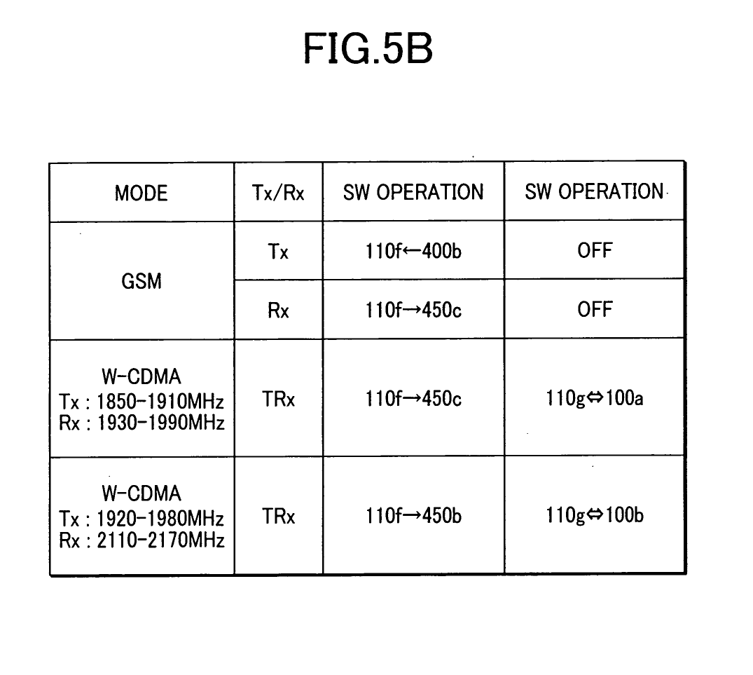

The fifth embodiment will be explained another example with reference to FIG. 5A and FIG. 5B. A multi-band multi-mode wireless communication device shown in FIG. 5A is an example of the cellular phone terminal corresponding to the single band GSM and dual band W-CDMA.

Like the first to fourth embodiments explained above, the frequency bands are defined as follows. First transmitted frequency is 1920 to 1980 MHz, the first received frequency is 2110 to 2170 MHz, the second transmitted frequency is 1850 to 1910 MHz, and the second received frequency is 1930 to 1990 MHz. Moreover, in this embodiment, the second transmitted and received frequencies are used for GSM, while both frequency bands of the first transmitted and received frequencies and the second transmitted and received frequencies are used for W-CDMA.

FIG. 5A is a circuit diagram showing a radio frequency circuit unit of the cellular phone terminal provided with the multi-band multi-mode communication device as the fifth embodiment of the present invention of FIG. 5A. Structure of the multi-band multi-mode communication device as the fifth embodiment of the present invention will be explained with reference to FIG. 5A.

20c and 20c′ denote D/A converters; 30d and 30d′ are A/D converters; 40d is a variable gain amplifier; 45g and 45f are variable gain amplifiers; 80e is a filter; 90c is a power amplifier; 100b is a duplexer; 110g is a seventh antenna; 120e, 120f are fifth and sixth switches; 200c is a modulator; 210d and 210e are demodulators; 220e and 220f are local oscillators.

400c denotes a transmitter circuit block mainly comprising the modulator 200c, variable gain amplifier 40d, filter 80e, and power amplifier 90c. 450d denotes a receiver circuit block mainly comprising the filter 85c, variable gain amplifier 45f and demodulator 210d. 450e denotes a receiver circuit block mainly comprising the variable gain amplifier 45g and demodulator 210e.

Next, operations of the multi-band multi-mode wireless communication device as the fifth embodiment of the present invention will be explained.

The transmitted digital I/Q signal corresponding to W-CDMA using the first transmitted frequency outputted from the base-band signal processor 10 is transmitted from the seventh antenna 110g via the duplexer 110a and sixth switch 120f after it has been converted to the transmitted analog I/Q signal by the D/A converter 20a and 20a′, frequency-converted to the first transmitted frequency by the modulator 200a, inputted to the power amplifier 90a as the first transmitted signal via the variable gain amplifier 40b and filter 80a, and amplified up to the transmitted power by the power amplifier 90a. Meanwhile, the received signal corresponding to W-CDMA using the first received frequency received by the seventh antenna 110g is converted to the digital signal by the A/D converters 30a and 30a′ and is then inputted to the base-band signal processor 10 as the first received digital I/Q signal after it has been inputted to the variable gain amplifier 45a via the sixth switch 120f and duplexer 100a, and demodulated into the received analog I/Q signal by the demodulator 210a.

With the operations explained above, a pair of transmitter/receiver circuit blocks 400a and 450a for W-CDMA using the first transmitted and received frequencies can be obtained.

Moreover, the transmitted digital I/Q signal corresponding to W-CDMA using the second transmitted frequency outputted from the base-band signal processor 10 is transmitted from the seventh antenna 110g via the duplexer 100b and sixth switch 120f after it has been converted to the transmitted analog I/Q signal by the D/A converters 20c and 20c′, frequency-converted to the second transmitted frequency by the modulator 200c, inputted to the power amplifier 90c as the second transmitted signal via the variable gain amplifier 40d and filter 80e, and amplified up to the transmitted power by the power amplifier 90c. Meanwhile, the received signal corresponding to W-CDMA using the second received frequency received by the seventh antenna 110g is converted to the digital signal by the A/D converters 30d and 30d′ and is then inputted to the base-band signal processor 10 as the second received digital I/Q signal after it has been inputted to the variable gain amplifier 45g via the sixth switch 120f and duplexer 110b, amplified by the variable gain amplifier 45g, and demodulated into the received analog I/Q signal by the demodulator 210e.

With the operations explained above, a pair of transmitter/receiver circuit blocks 400c and 450e for W-CDMA using the second transmitted and received frequencies can be obtained.

Moreover, the transmitted digital I/Q signal corresponding to the GSM using the second transmitted frequency outputted from the base-band signal processor 10 is transmitted from the sixth antenna 110f via the filter 80d and the fifth switch 120e after it has been converted to the transmitted analog I/Q signal in the D/A converters 20b and 20b′, frequency-converted to the second transmitted frequency in the modulator 200b, inputted as the third transmitted signal to the power amplifier 90b via the variable gain amplifier 40c and filter 80c, and amplified up to the transmitted power in the power amplifier 90b. Meanwhile, the received signal corresponding to the GMS using the second received frequency received with the sixth antenna 110f is converted to the digital signal in the A/D converters 30c and 30c′ and then inputted as the third received digital I/Q signal to the base-band signal processor 10 after it has been inputted to the variable gain amplifier 45f via the fifth switch 120e and filter 85c, amplified in the variable gain amplifier 45f, and demodulated to the received analog I/Q signal in the demodulator 210d.

With the operations explained above, a pair of transmitter/receiver circuits for the GSM using the second transmitted and received frequencies are obtained.

Moreover, the received signal corresponding to the W-CDMA using the first received frequency received by the sixth antenna 110f is converted to the digital signal by the A/D converters 30b and 30b′ and is then inputted to the base-band signal processor 10 as the fourth received digital I/Q signal after it has been inputted to the variable gain amplifier 45c via the fifth switch 120e and filter 85b, amplified by the variable gain amplifier 45c, and demodulated into the received analog I/Q signal in the demodulator 210b.

Moreover, the received signal corresponding to the W-CDMA using the second received frequency received by the sixth antenna 110f is converted to the digital signal by the A/D converters 30c and 30c′ and is then inputted as the fifth received digital I/Q signal to the base-band signal processor 10 after it has been inputted to the variable gain amplifier 45f via the fifth switch 120e and filter 85c, amplified by the variable gain amplifier 45f, and is demodulated to the received analog I/Q signal by the demodulator 210d.

Accordingly, the receiver circuit block 450d mainly constituted with the filter 85c, variable gain amplifier 45f and modulator 210d corresponds to both W-CDMA using the second received frequency and GSM using the second received frequency.

In the case of W-CDMA using the first transmitted and received frequencies, the base-band signal processor 10 synthesizes the first received digital I/Q signal and the fourth received digital I/Q signal after it compensates for phase and intensity of both signals. Moreover, in the case of W-CDMA using the second transmitted and received frequencies, the base-band signal processor 10 synthesizes the second received digital I/Q signal and the fifth received digital I/Q signal after it compensates for phase and intensity of both signals.

In the case of W-CDMA using the first transmitted and received frequencies, the sixth switch 120f is connected to the terminal connected to the duplexer 100a, while the sixth switch 120e is connected to the terminal connected to the filter 85b. Moreover, in the case of W-CDMA using the second transmitted and received frequencies, the sixth switch 120f is connected to the terminal connected to the duplexer 110b, while the fifth switch 120e is connected to the terminal connected to the filter 85c. In addition, in the case of GSM using the second transmitted and received frequencies, the fifth switch 120e is connected, in the transmitting state, to the terminal connected to the filter 80d, while the fifth switch 120e is connected, in the receiving state, to the terminal connected to the filter 85c.

The local oscillator 220e is the variable frequency oscillator to oscillate the first and second transmitted frequencies, while the local oscillator 220f is the variable frequency oscillator to oscillate the first and second received frequencies.

With structure and operations explained above, the multi-band multi-mode wireless communication device as the fifth embodiment of the present invention comprises, as shown in FIG. 5B, the wireless communication device having the diversity receiving function constituted with the receiver circuit block 450b in addition to a pair of transmitter/receiver circuit blocks for W-CDMA 400a and 450a using the first transmitted and received frequencies, the wireless communication device having the diversity receiving function constituted with the receiver circuit block 450d in addition to a pair of transmitter/receiver circuit blocks for W-CDMA 400c and 450e using the second transmitted and received frequencies, and a pair of transmitter/receiver circuit blocks 400b and 450d for GSM using the second transmitted and received frequencies.

Therefore, the multi-band multi-mode wireless communication device of this embodiment has the functions for operating the transmitter circuit block for W-CDMA, the first receiver circuit block for W-CDMA, the second receiver circuit block for W-CDMA, the transmitter circuit block for GSM and the receiver circuit block for GSM. Namely, the wireless communication circuit corresponding to the FDD system and the wireless communication circuit corresponding to the TDD system, having the W-CDMA diversity receiving function, are obtained with two antennas and two switches.

Principal effects of the multi-band multi-mode wireless communication device shown in FIG. 5 are as follows.

Reduction in size may be obtained in comparison with the cellular phone terminal which has required three antennas, by composing of two antennas of fifth 110f and sixth 110g, the cellular phone terminal corresponding to the single band GSM and dual band W-CDMA and to the diversity receiving in the W-CDMA.

The diversity receiver for W-CDMA using the second frequency can also be obtained without increase in the circuit area by using in common the receiver circuit block 450d for the GSM and W-CDMA in the second received frequency.

Although not shown in FIG. 5A, reduction in size of circuit or semiconductor device area may be obtained by mounting at least the variable gain amplifiers 45a, 45c, 45f and 45g, demodulators 210a, 210b, 210d and 210e, and local oscillators 220e and 220f on only one semiconductor device as in the case of the embodiments 1 to 4 explained above.

### Sixth Embodiment

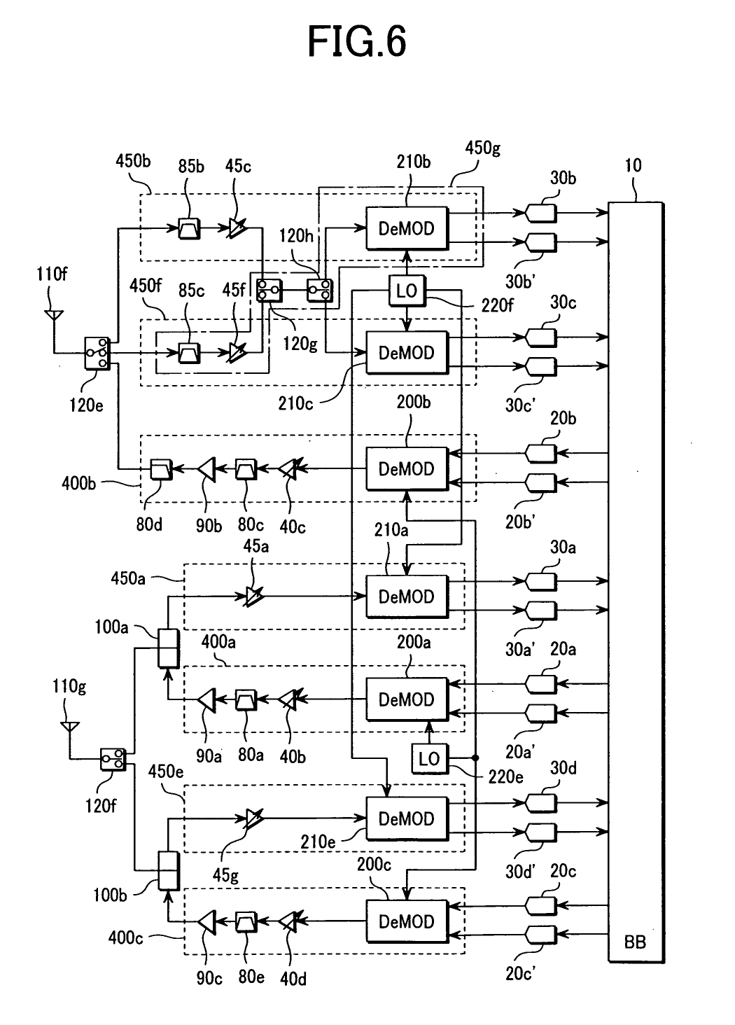

FIG. 6 is a circuit diagram showing a radio frequency circuit unit of a cellular phone terminal provided with a multi-band multi-mode wireless communication device as the sixth embodiment of the present invention. First, with reference to FIG. 6, a structure of the multi-band multi-mode wireless communication device of this sixth embodiment will be explained.

In FIG. 6, 120g, 120h denote the seventh and eighth switches; 450f, a receiver circuit block mainly constituted with filter 85c, variable gain amplifier 45f, seventh and eighth switches 120g, 120h and demodulator 210c; 450g, a receiver circuit block mainly constituted with filter 85c, variable gain amplifier 45f, seventh and eighth switches 120g, 120h, and demodulator 210b.

Difference from the fifth embodiment lies in that the variable gain amplifier 45c is connected to the demodulator 210b or 210c via the seventh and eighth switches 120g, 120h, and the variable gain amplifier 45f is also connected to the demodulator 210b or 210c via the seventh and eighth switches 120g, 120h.

Next, operations of the multi-band multi-mode wireless communication device of this sixth embodiment will be explained.

The received signal corresponding to the GSM using the second received frequency received by the sixth antenna 110f is converted to the digital signal by the A/D converters 30c and 30c′ and inputted as the third received digital I/Q signal to the base-band signal processor 10, after it has been inputted to the variable gain amplifier 45f via the fifth switch 120e and filter 85c, amplified by the variable gain amplifier 45f, inputted to the demodulator 210c via the seventh and eighth switches 120g, 120h, and demodulated to the received analog I/Q signal by the demodulator 210c.

Meanwhile, the received signal corresponding to the W-CDMA using the first received frequency received by the sixth antenna 110f is converted to the digital signal by the A/D converters 30b and 30b′ and inputted as the fourth received digital I/Q signal to the base-band signal processor 10, after it has been inputted to the variable gain amplifier 45c via the fifth switch 120e and filter 85c, amplified by the variable gain amplifier 45c, inputted to the demodulator 210b via the seventh and eighth switches 120g, 120h, and demodulated into the received analog I/Q signal by the demodulator 210b.

Moreover, the received signal corresponding to the W-CDMA using the second received frequency received by the sixth antenna 110f is converted to the digital signal by the A/D converters 30b and 30b′ and inputted as the fifth received digital I/Q signal to the base-band signal processor 10, after it has been inputted to the variable gain amplifier 45f via the fifth switch 120e and filter 85c, amplified by the variable gain amplifier 45f, inputted to the demodulator 210b via the seventh and eighth switch 120g, 120h, and demodulated to the received analog I/Q signal by the demodulator 210b.

In the case of GSM using the second received frequency, the seventh switch 120g is connected to the terminal connected to the variable gain amplifier 45f, while the eighth switch 120h is connected to the terminal connected to the demodulator 120c. Moreover, in the case of W-CDMA using the first received frequency, the seventh switch 120g is connected to the terminal connected to the variable gain amplifier 45c, while the eighth switch 120h is connected to the terminal connected to the demodulator 210b. In addition, in the case of W-CDMA using the second received frequency, the seventh switch 120g is connected to the terminal connected to the variable gain amplifier 45f, while the eighth switch 120h is connected to the terminal connected to the demodulator 210b.

As the structure and operations of this sixth embodiment are explained above, the filter 85c and variable gain amplifier 45f are used in common in the second receiver frequency for both GSM and W-CDMA. The difference from the fifth embodiment is that the demodulator 210c is used as the demodulator for the GSM and the demodulator 210b is used while for the W-CDMA.

Principal effects of the multi-band multi-mode wireless communication device as the sixth embodiment of the present invention of FIG. 6 are as follows.

Since the demodulator 210b demodulates only the received signal corresponding to the W-CDMA, while the demodulator 210c demodulates only the received signal corresponding to the GSM, design of the demodulator can be more simplified and improved in performance in comparison with the demodulator 210d for demodulating the received signal corresponding to the GSM and W-CDMA in the fifth embodiment explained above.

### Seventh Embodiment

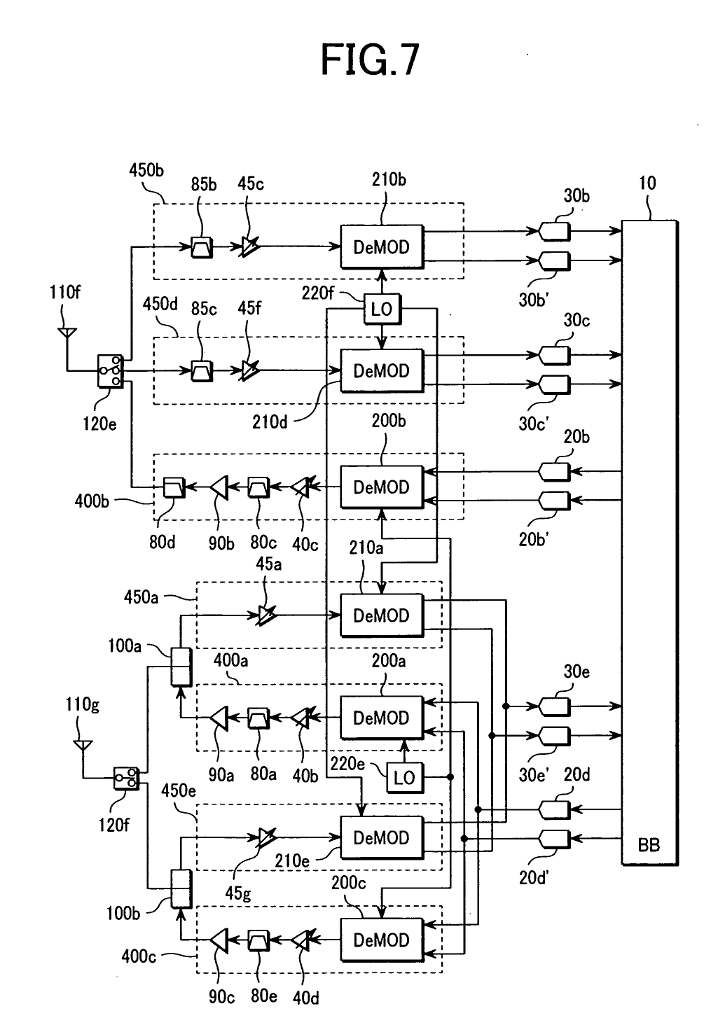

FIG. 7 is a circuit diagram showing a radio frequency circuit unit of a cellular phone terminal provided with the multi-band multi-mode wireless communication device as the seventh embodiment of the present invention. First, with reference to FIG. 7, a structure of the multi-band multi-mode wireless communication device of the seventh embodiment of the present invention will be explained below.

In FIG. 7, 20d and 20d′ denote D/A converters, while 30e and 30e′, A/D converters, respectively.

Next, operations of the multi-band multi-mode wireless communication device as the seventh embodiment of the present invention will be explained with reference to FIG. 7.

The transmitted digital I/Q signal corresponding to the W-CDMA using the first transmitted frequency outputted from the base-band signal processor 10 is transmitted from the seventh antenna 110g via the duplexer 110a and sixth switch 120f after it has been converted to the transmitted analog I/Q signal by the D/A converters 20d and 20d′, frequency-converted to the first transmitted frequency by the demodulator 200a, inputted as the first transmitted signal to the power amplifier 90a via the variable gain amplifier 40b and filter 80a, and amplified up to the transmitted power by the power amplifier 90a. Meanwhile, the received signal corresponding to the W-CDMA using the first received frequency received by the seventh antenna 110g is converted to the digital signal by the A/D converters 30e and 30e′ and inputted as the first received digital I/Q signal to the base-band signal processor 10, after it has been inputted to the variable gain amplifier 45a via the sixth switch 120f and duplexer 100a, amplified by the variable gain amplifier 45a, and demodulated into the received analog I/Q signal by the demodulator 210a.

Moreover, the transmitted digital I/Q signal corresponding to the W-CDMA using the second transmitted frequency outputted from the base-band signal processor 10 is transmitted from the seventh antenna 10 g via the duplexer 100b and sixth switch 120f, after it has been converted to the transmitted analog I/Q signal by the D/A converters 20d and 20d′, frequency-converted to the second transmitted frequency by the demodulator 200c, inputted as the second transmitted signal via the variable gain amplifier 40d and filter 80e, and amplified up to the transmitted power by the power amplifier 90c. On the other hand, the received signal corresponding to the W-CDMA using the second received frequency received by the seventh antenna 110g is converted to the digital signal by the A/D converters 30e and 30d′ and inputted as the second received digital I/Q signal to the base-band signal processor 10, after it has been inputted to the variable gain amplifier 45g via the sixth switch 120f and duplexer 100b, amplified by the variable gain amplifier 45g, and demodulated into the received analog I/Q signal by the demodulator 210c.

As the operations are explained above, the seventh embodiment is different from the fifth and sixth embodiments in that the D/A converter and A/D converter are used in common in the W-CDMA using the first transmitted and received frequencies and in the W-CDMA using the second transmitted and received frequencies.

Principal effects of the multi-band multi-mode communication device as the seventh embodiment of FIG. 7 are as follows.

The multi-band multi-mode wireless communication device as the seventh embodiment of the present invention of FIG. 7 can be reduced in size thereof in comparison with the fifth and sixth embodiments explained above by providing in common the D/A converters and A/D converters for the W-CDMA using the first transmitted and received frequencies and the W-CDMA using the second transmitted and received frequencies.

### Eighth Embodiment

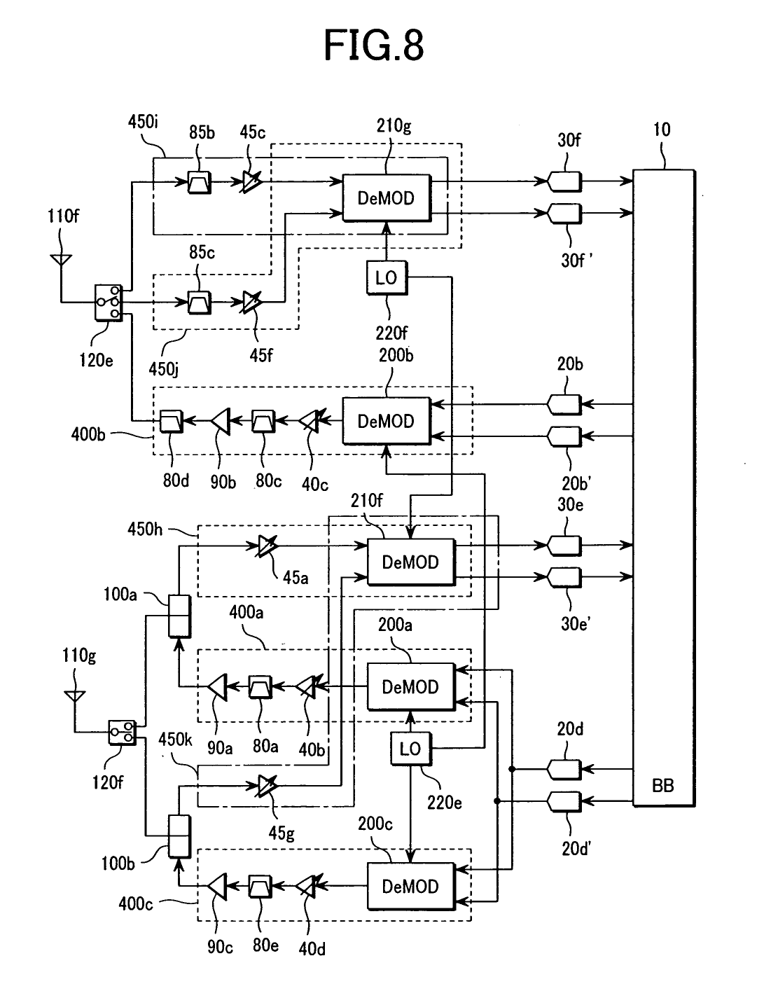

FIG. 8 is a circuit diagram showing a radio frequency circuit unit of a cellular phone terminal provided with the multi-band multi-mode wireless communication device as the eighth embodiment of the present invention. First, with reference to FIG. 8, a structure of the multi-band multi-mode wireless communication device as the eighth embodiment of the present invention will be explained.

In FIG. 8, 30f and 30f′ denote A/D converters, while 210f and 210g, demodulators.

450h denotes a receiver circuit block mainly constituted with variable gain amplifier 45a and demodulator 210f, while 450i, a receiver circuit block mainly constituted with filter 85b, variable gain amplifier 45c and demodulator 210g. 450j, a receiver circuit block mainly constituted with filter 85c, variable gain amplifier 45f and demodulator 210g, and 450k, a receiver circuit block mainly constituted with variable gain amplifier 45g and demodulator 210f.

The difference from the seventh embodiment explained above is that the variable gain amplifiers 45a and 45g are connected to the demodulator 210f, while the variable gain amplifiers 45c and 45f, to the demodulator 210g.

Next, with reference to FIG. 8, operations of the multi-band multi-mode wireless communication device as the eighth embodiment of the present invention will be explained.

The received signal corresponding to the W-CDMA using the first received frequency received by the seventh antenna 110g is converted to the digital signal by the A/D converters 30e and 30e′ and inputted as the first received digital I/Q signal to the base-band signal processor 10, after it has been inputted to the variable gain amplifier 45a via the sixth switch 120f and duplexer 100a, amplified by the variable gain amplifier 45a and demodulated to the received analog I/Q signal by the demodulator 210f.

Moreover, the received signal corresponding to the W-CDMA using the second received frequency received by the seventh antenna 110g is converted to the digital signal by the A/D converters 30e and 30e′ and inputted as the second received digital I/Q signal to the base-band signal processor, after it has been inputted to the variable gain amplifier 45g via the sixth switch 120f and duplexer 100b, amplified by the variable gain amplifier 45g, and demodulated to the received analog I/Q signal by the demodulator 210f.

On the other hand, the received signal corresponding to the GSM using the second received frequency received by the sixth antenna 110f is converted to the digital signal by the A/D converters 30f and 30f′ and inputted as the third received digital I/Q signal to the base-band signal processor 10, after it has been inputted to the variable gain amplifier 45f via the fifth switch 120e and filter 85c, amplified by the variable gain amplifier 45f, and demodulated to the received analog I/Q signal by the demodulator 210g.

Moreover, the received signal corresponding to the W-CDMA using the first received frequency received by the sixth antenna 110f is converted to the digital signal by the A/D converters 30f and 30f′ and inputted as the fourth received digital I/Q signal, after it has been inputted to the variable gain amplifier 45c via the fifth switch 120e and filter 85b, amplified by the variable gain amplifier 45c, and demodulated to the received analog I/Q signal by the demodulator 210g.

In addition, the received signal corresponding to the W-CDMA using the second received frequency received by the sixth antenna 110f is converted to the digital signal by the A/D converters 30f and 30f′ and inputted as the fifth received digital I/Q signal by the base-band signal processor 10, after it has been inputted to the variable gain amplifier 45f via the fifth switch 120e and filter 85c, amplified by the variable gain amplifier 45f, and demodulated to the received analog I/Q signal by the demodulator 210g.

As the structure and operations are explained above, this eighth embodiment is different from the seventh embodiment explained above in that the demodulator 210f connected to the seventh antenna 110g is used in common as the demodulator for the received signal of the first received frequency W-CDMA and the second received frequency W-CDMA, while the demodulator 210g connected to the sixth antenna 110f is used in common as the demodulator for the received signal of the W-CDMA using the first received frequency, W-CDMA using the second received frequency and GSM using the second received frequency.

Principal effects of the multi-band multi-mode wireless communication device of this eights embodiment of the present invention of FIG. 8 are as follows.

The multi-band multi-mode wireless communication device of the eighth embodiment of FIG. 8 is capable of reducing the size of circuit area in comparison with that of the fifth to seventh embodiments explained above by using in common the demodulator 210f as the demodulator of the received signal of the first received frequency W-CDMA and the second received frequency W-CDMA, and using in common the demodulator 210g connected to the sixth antenna 110f as the demodulator of the received signal of the W-CDMA using the second received frequency and the GSM using the second received frequency.

### Ninth Embodiment

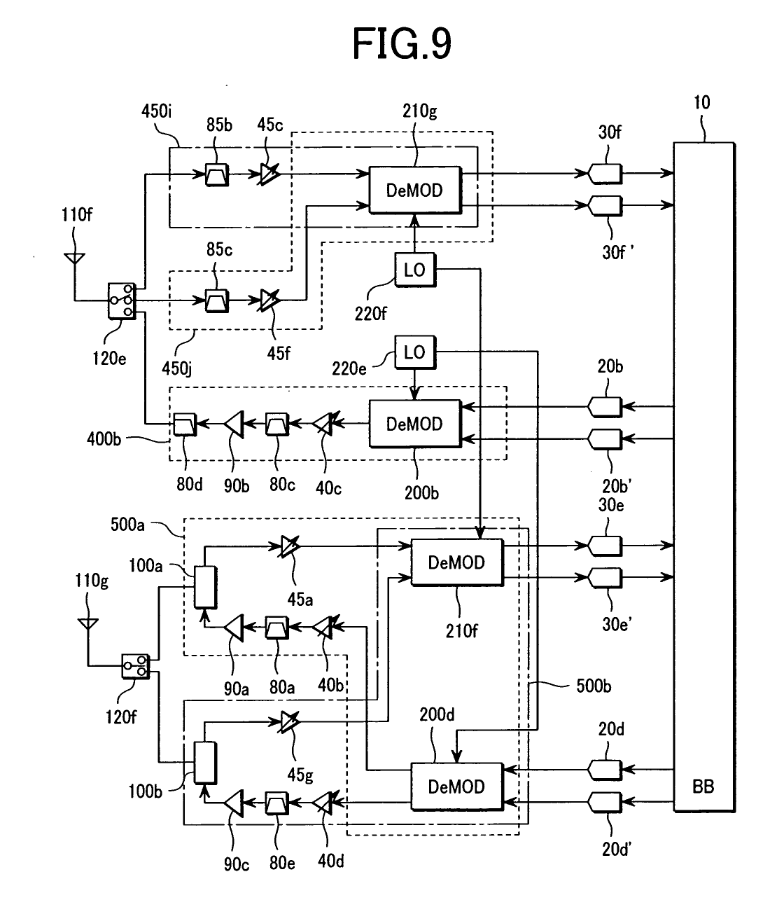

FIG. 9 is a circuit diagram showing a radio frequency circuit unit of a cellular phone terminal provided with a multi-band multi-mode wireless communication device as the ninth embodiment of the present invention. First, a structure of the multi-band multi-mode wireless communication device as the ninth embodiment of the present invention will be explained with reference to FIG. 9.

In FIG. 9, 200d denotes a modulator. 500a, a transmitter/receiver circuit block mainly constituted with modulator 200d, variable gain amplifier 40b, filter 80a, power amplifier 90a, duplexer 110a, variable gain amplifier 45a, and demodulator 210f. 500b, a transmitter/receiver circuit block mainly constituted with modulator 200d, variable gain amplifier 40d, filter 80e, power amplifier 90c, duplexer 110b, variable gain amplifier 45g and demodulator 210f.

The ninth embodiment is different from the eighth embodiment explained above in that the variable gain amplifiers 40b and 40d are connected to the modulator 200d.

Next, operations of the multi-band multi-mode wireless communication device as the ninth embodiment of the present invention will be explained with reference to FIG. 9.

The transmitted digital I/Q signal corresponding to the W-CDMA using the first transmitted frequency outputted from the base-band signal processor 10 is transmitted from the seventh antenna 110g via the duplexer 100a and sixth switch 120f, after it has been converted to the transmitted analog I/Q signal by the D/A converters 20d and 20d′, frequency-converted to the first transmitted frequency by the modulator 200d, inputted to the power amplifier 90a as the first transmitted signal via the variable gain amplifier 40b and filter 80a, and amplified up to the transmitted power by the power amplifier 90a.

Meanwhile, the transmitted digital I/Q signal corresponding to the W-CDMA using the second transmitted frequency outputted from the base-band signal processor 10 is transmitted from the seventh antenna 110g via the duplexer 100b and sixth switch 120f, after it has been converted to the transmitted analog I/Q signal by the D/A converters 20d and 20d′, frequency-converted to the second transmitted frequency by the modulator 200d, inputted as the second transmitted signal to the power amplifier 90c via the variable gain amplifier 40d and filter 80e, and amplified up to the transmitted power by the power amplifier 90c.

As the structure and operations are explained above, this ninth embodiment is different from the eighth embodiment in that the modulator 200d is used in common as the modulator of the W-CDMA using the first transmitted frequency and that of the W-CDMA using the second transmitted frequency.

Principal effects of the multi-band multi-mode wireless communication device as the ninth embodiment of FIG. 9 are as follows.

The Multi-band multi-mode wireless communication device as the ninth embodiment of FIG. 9 is capable of reducing the circuit area in comparison with the fifth to eighth embodiments by using in common the modulator 200d as the modulator of the W-CDMA using the first transmitted frequency and that of the W-CDMA using the second transmitted frequency.

### Tenth Embodiment

The fifth to ninth embodiments of the present invention have explained, as an example, the cellular phone terminals corresponding to the single-band GSM and dual-band W-CDMA. The multi-band multi-mode wireless communication device of the tenth embodiment of the present invention explains, as the other embodiment, a cellular phone terminal corresponding to the dual-band GSM and dual-band W-CDMA.

Frequency bands are defined as follows; the first transmitted frequency is 1920 to 1980 MHz, the first received frequency is 2110 to 2170 MHz, the second transmitted frequency is 1850 to 1910 MHz, the second received frequency is 1930 to 1990 MHz, the third transmitted frequency is 1710 to 1785 MHz, and the third received frequency is 1805 to 1880 MHz. Moreover, in an example explained below, the second transmitted and received frequencies and the third transmitted and received frequencies are used for the GSM, while the first transmitted and received frequencies and the second transmitted and received frequencies are used for the W-CDMA.

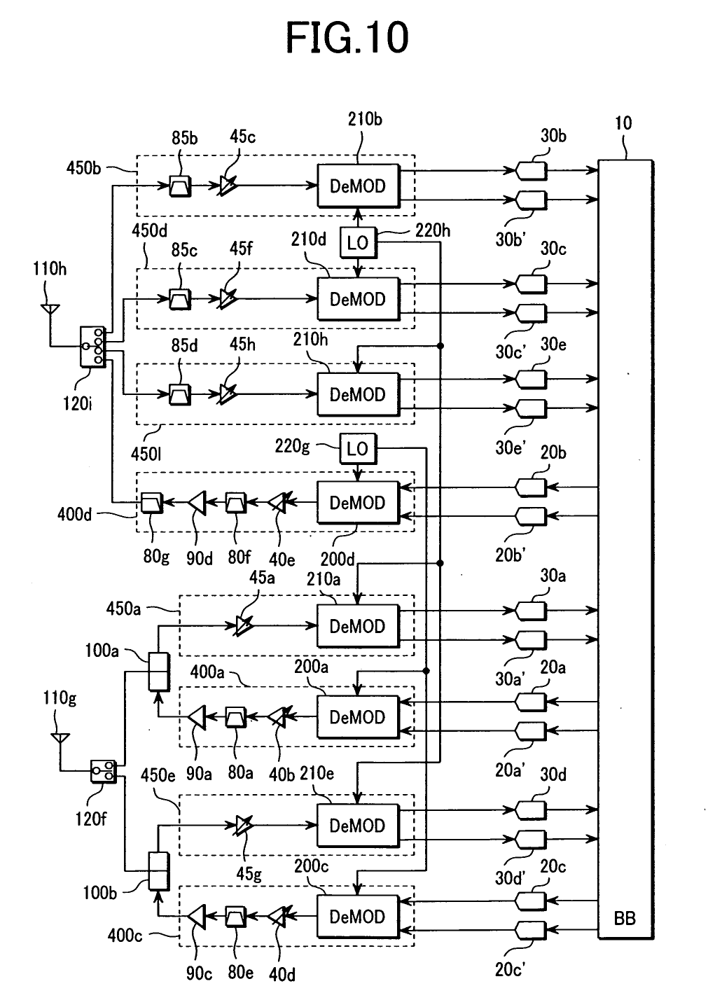

FIG. 10 is a circuit diagram showing a radio frequency circuit unit of a cellular phone terminal provided with the multi-band multi-mode wireless communication device as the tenth embodiment of the present invention. First, with reference to FIG. 10, a structure of the multi-band multi-mode wireless communication device as the tenth embodiment of the present invention will be explained below.

In FIG. 10, 30c and 30c′ denote A/D converters; 40e is variable gain amplifier; 45g is variable gain amplifier; 80f and 80g are filters; 85d is filter; 90d is power amplifier; 120i is ninth switch; 110h is eighth antenna; 200d is modulator; 210h is demodulator; 220g and 220h are local oscillators.

400d denotes a transmitter circuit block mainly constituted with the modulator 200d, variable gain amplifier 40e, filters 80f and 80g, and power amplifier 90d, while 4501, a receiver circuit block mainly constituted with a filter 85d, a variable gain amplifier 45g, and a demodulator 210h.

Next, with reference to FIG. 10, operations of the multi-band multi-mode wireless communication device of the tenth embodiment of the present invention will be explained.

The transmitted digital I/Q signal corresponding to the W-CDMA using the first transmitted frequency outputted from the base-band signal processor 10 is transmitted from the seventh antenna 10g via the duplexer 100a and sixth switch 120f, after it has been converted to the transmitted analog I/Q signal by the D/A converters 20a and 20a′, frequency-converted to the first transmitted frequency by the modulator 200a, inputted as the first transmitted signal to the power amplifier 90a via the variable gain amplifier 40b and filter 80a, and amplified up to the transmitted power by the power amplifier 90a. Meanwhile, the received signal corresponding to the W-CDMA using the first received frequency received by the seventh antenna 110g is converted to the digital signal by the A/D converters 30a and 30a′ and inputted as the first received digital I/Q signal to the base-band signal processor 10, after it has been inputted to the variable gain amplifier 45a via the sixth switch 120f and duplexer 100a, amplified by the variable gain amplifier 45a, and demodulated to the received analog I/Q signal by the demodulator 210a.

With the operations explained above, a pair of transmitter/receiver circuit block 400a and 450a for the W-CDMA using the first transmitted and received frequencies may be obtained.

The transmitted digital I/Q signal corresponding to the W-CDMA using the second transmitted frequency outputted from the base-band signal processor 10 is transmitted from the seventh antenna 110g via the duplexer 100b and sixth switch 120f, after it has been converted to the transmitted analog I/Q signal by the D/A converters 20c and 20c′, frequency-converted to the second transmitted frequency by the modulator 200c, inputted as the second transmitted signal to the power amplifier 90c via the variable gain amplifier 40d and filter 80e, and amplified up to the transmitted power by the power amplifier 90c. Meanwhile, the received signal corresponding to the W-CDMA using the second received frequency received by the seventh antenna 110g is converted to the digital signal by the A/D converters 30d and 30d′ and inputted as the second received digital I/Q signal to the base-band signal processor 10, after it has been inputted to the variable gain amplifier 45g via the sixth switch 120f and duplexer 10b, amplified by the variable gain amplifier 45g, and demodulated to the received analog I/Q signal by the demodulator 210e.

With operations explained above, a pair of transmitter/receiver circuit blocks 400c and 450e for the W-CDMA using the second transmitted and received frequencies may be obtained.

The transmitted digital I/Q signal corresponding to the GSM using the second transmitted frequency outputted from the base-band signal processor 10 is transmitted from the eighth antenna 110h via the ninth switch 120i, after it has been converted to the transmitted analog I/Q signal by the D/A converters 20b and 20b′, frequency-converted to the second transmitted frequency by the modulator 200d, inputted as the second transmitted signal to the power amplifier 90d via the variable gain amplifier 40e and filter 80f, and amplified up to the transmitted power by the power amplifier 90d. Meanwhile, the received signal corresponding to the GSM using the second received frequency received by the eight antenna 110h is converted to the digital signal by the A/D converters 30c and 30c′ and inputted as the third received digital I/Q signal to the base-band signal processor 10, after it has been inputted to the variable gain amplifier 45f via the ninth switch 120i and filter 85c, amplified by the variable gain amplifier 45f, and demodulated to the received analog I/Q signal by the demodulator 210d.

With the operations explained above, a pair of transmitter/receiver circuit blocks 400d and 450d for the GSM using the second transmitted and received frequencies may be obtained.

The transmitted digital I/Q signal corresponding to the GSM using the third transmitted frequency outputted from the base-band signal processor 10 is transmitted from the eighth antenna 110h via the ninth switch 120i, after it has been converted to the transmitted analog I/Q signal by the D/A converters 20b and 20b′, frequency-converted to the third transmitted frequency by the modulator 200d, inputted as the third transmitted signal to the power amplifier 90d via the variable gain amplifier 40e and filter 80f, and amplified up to the transmitted power by the power amplifier 90d. Meanwhile, the received signal corresponding to the GSM using the third received frequency received by the eighth antenna 110h is converted to the digital signal by the A/D converters 30e and 30e′ and inputted as the fourth received digital I/Q signal to the base-band signal processor 10, after it has been inputted to the variable gain amplifier 45h via the ninth switch 120i and filter 85d, amplified by the variable gain amplifier 45h, and demodulated to the received analog I/Q signal by the demodulator 210h.

With operations explained above, a pair of transmitter/receiver circuit blocks 400d and 4501 for the GSM using the third transmitted and received frequencies may be obtained.

Moreover, the received signal corresponding to the W-CDMA using the first received frequency received by the eighth antenna 110h is converted to the digital signal by the A/D converters 30b and 30b′ and inputted as the fifth received digital I/Q signal to the base-band signal processor 10, after it has been inputted to the variable gain amplifier 45c via the ninth switch 120i and filter 85b, amplified by the variable gain amplifier 45c, and demodulated to the received analog I/Q signal by the demodulator 210b.

Furthermore, the received signal corresponding to the W-CDMA using the second received frequency received by the eighth antenna 110h is converted to the digital signal by the A/D converters 30c and 30c′ and inputted as the sixth received digital I/Q signal to the base-band signal processor 10, after it has been inputted to the variable gain amplifier 45f via the ninth switch 120i and filter 85c, amplified by the variable gain amplifier 45f, and demodulated to the received analog I/Q signal by the demodulator 210d.

Accordingly, the transmitter circuit block 400d mainly constituted with the modulator 200d, variable gain amplifier 40e, filters 80f and 80g, and power amplifier 90d corresponds to both GSM using the second transmitted frequency and GSM using the third transmitted frequency.

In addition, the receiver circuit block 450d mainly constituted with filter 85c, variable gain amplifier 45f and modulator 210d corresponds to both W-CDMA using the second received frequency and GSM using the second received frequency.

In the case of the W-CDMA using the first transmitted and received frequencies, the base-band signal processor 10 synthesizes the first received digital I/Q signal and the fifth received digital I/Q signal after compensation for phase and intensity thereof. Moreover, in the case of the W-CDMA using the second transmitted and received frequency, the base-band signal processor 10 synthesizes the second received digital I/Q signal and the sixth received digital I/Q signal after compensation for phase and intensity thereof.

In the case of the W-CDMA using the first transmitted and received frequencies, the sixth switch 120f is connected to the terminal connected to the duplexer 100a, while the ninth switch 120i is connected to the terminal connected to the filter 85b. Moreover, in the case of the W-CDMA using the second transmitted and received frequencies, the sixth switch 120f is connected to the terminal connected to the duplexer 100b, while the ninth switch 120i is connected to the terminal connected to the filter 85c. Moreover, in the case of the GSM using the second transmitted and received frequencies, the ninth switch 120i is connected to the terminal connected to the filter 80g in the transmitting state, and the ninth switch 120i is connected to the terminal connected to the filter 85c in the receiving state. In addition, in the case of the GSM using the third transmitted and received frequencies, the ninth switch 120i is connected to the terminal connected to the filter 80g in the transmitting state and is connected to the terminal connected to the filter 85d in the receiving state.

The local oscillator 220g is a variable frequency oscillator for oscillating the first to third transmitted frequencies, while the local oscillator 220h is a variable frequency oscillator for oscillating the first to third received frequencies.

With the structure and operations explained above, the multi-band multi-mode wireless communication device of the tenth embodiment of the present invention of FIG. 10 is provided with the wireless communication device having the diversity receiving function constituted with the receiver circuit block 450b in addition to a pair of transmitter/receiver circuit blocks 400a and 450a for the W-CDMA using the first transmitted and received frequencies, the wireless communication device having the diversity receiving function constituted with the receiver circuit block 450d in addition to a pair of transmitter/receiver circuit blocks 400c and 450e for the W-CDMA using the second transmitted and received frequencies, the transmitter circuit block 400d for the GSM using the second and third transmitter frequency, the receiver circuit block 450d for the GSM using the second received frequency, and the receiver circuit block 4501 for the GSM using the third received frequency.

Principal effects of the multi-band multi-mode wireless communication device of the tenth embodiment of the present invention of FIG. 10 are as follows.

More reduction in size in comparison with the cellular phone terminal having required three antennas may be enabled by realizing the cellular phone terminal corresponding to the dual-band GSM and dual-band W-CDMA and to the diversity receiving in the W-CDMA using two seventh and eighth antennas 110g, 110h.

The diversity receiver for the W-CDMA using the second frequency may be obtained without increase in the circuit area by using in common the receiver circuit block 450d for both GSM and W-CDMA in the second received frequency.

Moreover, the transmitter circuit for the dual-band GSM may also be obtained without increase the circuit area by using in common the transmitter circuit block 400d in the GSM using the second transmitted frequency and the GSM using the third frequency.

Although not illustrated in FIG. 10, reduction in size of circuit or semiconductor device may be enabled, like the first to ninth embodiments explained above, by mounting, to only one semiconductor device, at least the variable gain amplifiers 45a, 45c, 45f to 45h, demodulators 210a, 210b, 210d, 210e and 210h, local oscillators 220g and 220h.

### Eleventh Embodiment

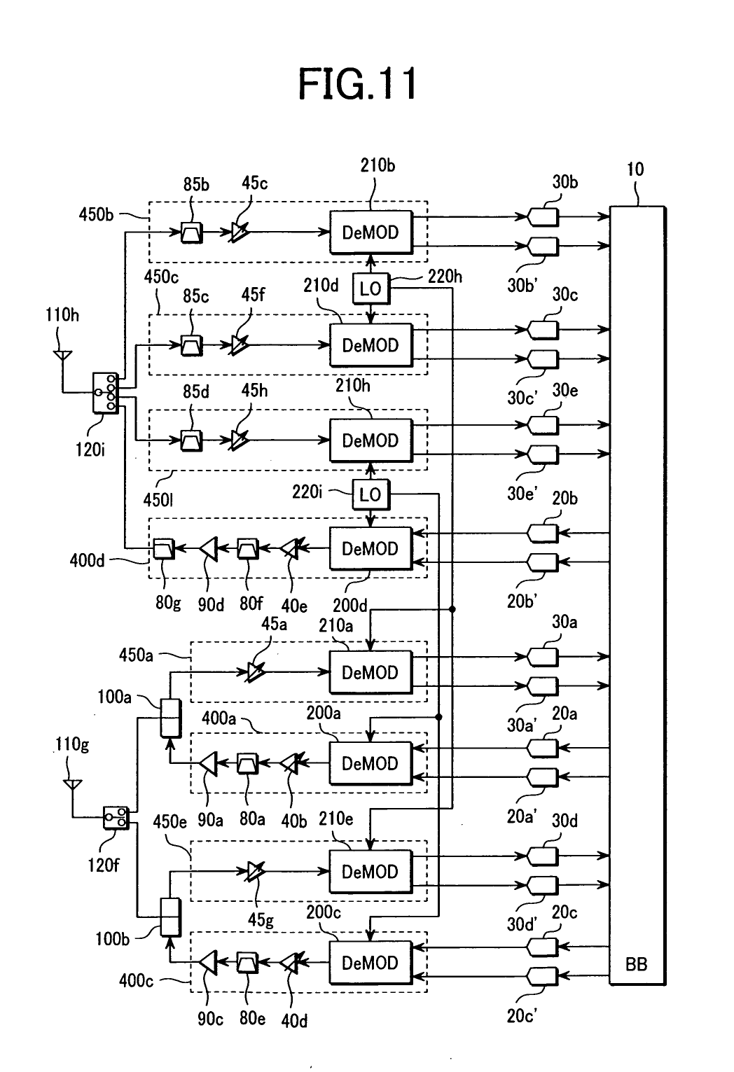

FIG. 11 is a circuit diagram showing a radio frequency circuit unit of a cellular phone terminal provided with a multi-band multi-mode wireless communication device as an eleventh embodiment of the present invention. With reference to FIG. 11, a structure of the multi-band multi-mode wireless communication device of the eleventh embodiment of the present invention will be explained below.

In FIG. 11, 220i denotes a local oscillator. This eleventh embodiment is different from the tenth embodiment explained above in that the local oscillator 220i is connected to the modulators 200a, 200c, 200d and demodulator 210h, while the local oscillator 220f is connected to the demodulators 210a, 210b, 210d and 210e.

Next, with reference to FIG. 11, operations of the multi-band multi-mode wireless communication device as the eleventh embodiment of the present invention will be explained.

Operations of the multi-band multi-mode wireless communication device as the eleventh embodiment of the present invention of FIG. 11 are basically identical to that of the tenth embodiment and the difference between these embodiments is only that the local oscillator 220i is a variable frequency oscillator to oscillate the first to third transmitted frequency and the third received frequency. Since the transmitting and receiving operations are conducted respectively in different periods for the GSM operation, it is possible to use in common the local oscillator connected to the demodulator and to change the oscillated frequency in respective periods.

Effects of the multi-band multi-mode wireless communication device of the eleventh embodiment of FIG. 11 are identical to that of the tenth embodiment.

### Twelfth Embodiment

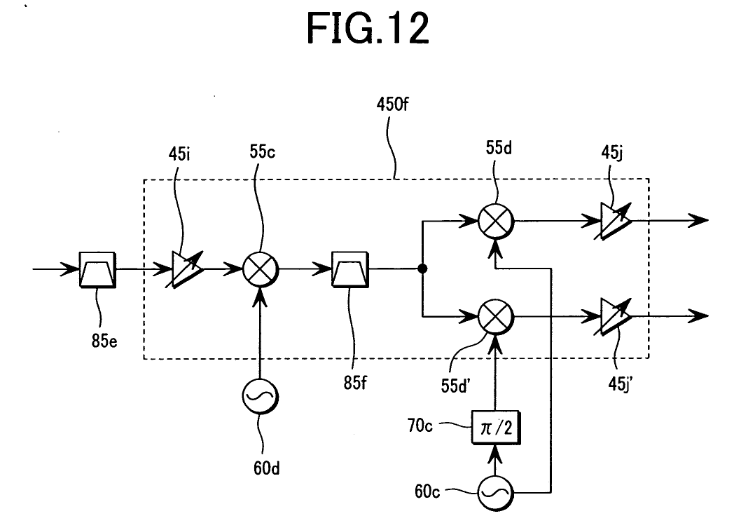

FIG. 12 is a circuit diagram showing a receiver circuit block of a cellular phone terminal provided with a multi-band multi-mode wireless communication device as the twelfth embodiment of the present invention. First, a structure of the receiver circuit block of the multi-band multi-mode communication device of the twelfth embodiment of the present invention will be explained with reference to FIG. 12.

45i, 45j, and 45j′ denote variable gain amplifiers; 55c, 55d and 55d′ are mixers; 60c and 60d are oscillators; 70b is a phase shifter, 85e and 85f are filters.

Next, with reference to FIG. 12, operations of the receiver circuit block of the multi-band multi-mode wireless communication device of the twelfth embodiment of the present invention will be explained.

The received signal inputted to the variable gain amplifier 45i via the filter 85e is inputted to the mixer 55c after it has been amplified by the variable gain amplifier 45i. The oscillator 60d is connected to oscillate the frequency different by several hundreds kHz from the received frequency and is connected to the mixer 55c. The received signal is divided into two signals and then inputted to the mixers 55d and 55d′ passing the filter 85f, after it has been converted to the received intermediate signal of several hundreds of kHz by the mixer 55c. The oscillator 60c oscillates the frequency of several hundreds of kHz and is connected to the mixers 55d and 55d′. Since the mixers 55d and 55d′ are required to generate a difference of 90 degrees in the phase of the I/Q signal, the phase shifter 70c is inserted between the mixer 55d′ and oscillator 60c. The received intermediate frequency signal inputted to the mixer 55d is converted to the base-band frequency and is then amplified by the variable gain amplifier 45j as the received analog I signal. Meanwhile, the received intermediate frequency signal inputted to the mixer 55d′ is converted to the base-band frequency and is then amplified as the received analog Q signal by the variable gain amplifier 45j′. The demodulation system explained above is generally called the low IF (Intermediate Frequency) down-conversion.

Principal effects of the receiver circuit block of the multi-band multi-mode wireless communication device of the twelfth embodiment of the present invention of FIG. 12 are as follows.

In the direct down-conversion in the twelfth embodiment explained above, an interference wave near the received frequency is also converted to the base-band frequency and such interference wave results in reduction in the sensitivity, because the received signal is frequency-converted directly to the base-band frequency from the received frequency. Meanwhile, the receiver circuit block of the multi-band multi-mode wireless communication device of the twelfth embodiment of FIG. 12 is capable of reducing influence of the interference wave and improving the receiving sensitivity by eliminating the interference wave with the filter 85f, because the received signal amplified by the variable gain amplifier 45i is converted to the intermediate frequency of several hundreds of kHz and converted to the frequency different from the interference wave by the mixer 55c.

The receiver circuit block of the multi-band multi-mode wireless communication device of the twelfth embodiment of FIG. 12 may be applied to the receiver circuit blocks of the first to eleventh embodiments explained above.

### Thirteenth Embodiment

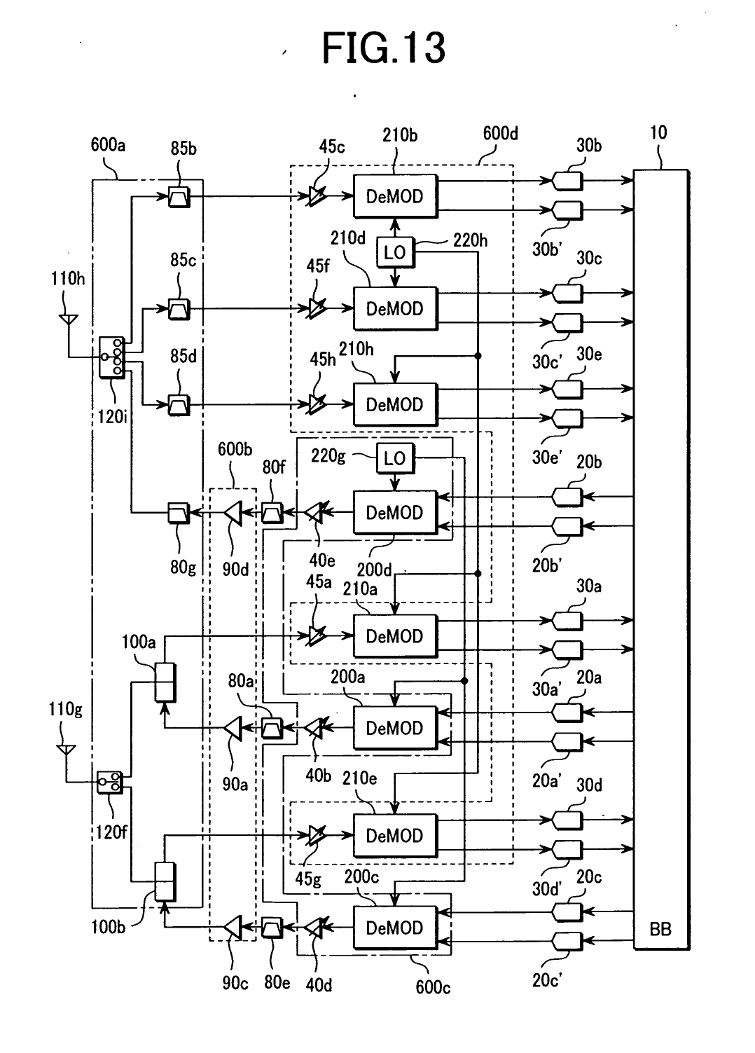

FIG. 13 is a block diagram showing module structures of front-end unit and modulation and demodulation unit in a radio frequency circuit unit of a cellular phone terminal provided with a multi-band multi-mode wireless communication device as the thirteenth embodiment of the present invention. First, with reference to FIG. 13, a structure of the multi-band multi-mode wireless communication device of the present invention will be explained.

In FIG. 13, 600a denotes a profile of module constituting a front-end unit mainly constituted with filter 80g, filters 85b to 85d and duplexers 110a and 110b. 600b denotes a profile of module constituting a front-end unit mainly constituted with power amplifiers 90a, 90c, and 90d. 600c denotes a profile of module constituting a modulator/demodulator unit mainly constituted with variable gain amplifiers 40a, 40b and 40d, modulators 200a, 200c and 200d, and local oscillator 220g. 600d denotes a profile of module constituting a modulator/demodulator constituted with variable gain amplifiers 45a, 45f to 45h, demodulators 210a, 210b, 210d, 210e and 210h, and local oscillator 220h.

The filters 80a, 80e and 80f may be formed in the module 600c.

Principal effects of the receiver circuit block of the multi-band multi-mode wireless communication device of the thirteenth embodiment of the present invention of FIG. 13 are as follows.

As the module constituting the front-end unit, the filter and duplexer mainly constituted with passive components are formed into only one module and are then mounted to the power amplifier mainly constituted with active components. Therefore, each module can be easily designed. Moreover, since each module can be designed individually, the circuit can be optimized easily and power consumption can also be lowered.

Moreover, since the demodulator/modulator unit comprises individually the module constituted with the modulator and the module constituted with the demodulator, transmitting and receiving interferences can be lowered easily and thereby receiving sensitivity can also be improved.

### Fourteenth Embodiment

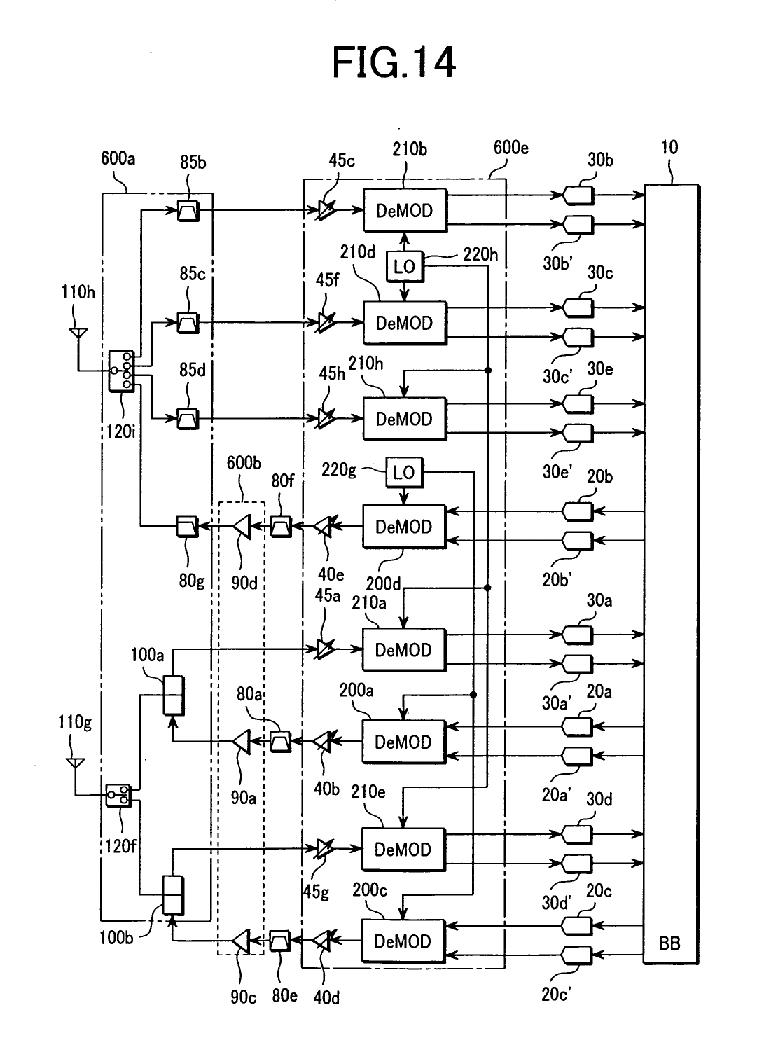

FIG. 14 is a block diagram showing a module structure of a radio frequency circuit unit of a cellular phone terminal provided with the multi-band multi-mode wireless communication device as the fourteenth embodiment of the present invention. First, a structure of the multi-band multi-mode wireless communication device as the fourteenth embodiment of the present invention will be explained.

In FIG. 14, 600e denotes a profile of module constituted with modules 600c and 600d. The filters 80a, 80e and 80f may be formed in the module 600e. Namely, the front-end unit and the modulator/demodulator unit are formed to the integrated module as the module 600e.

Principal effects of the receiver circuit block of the multi-band multi-mode wireless communication device of the fourteenth embodiment of the present invention are as follows.

The multi-band multi-mode wireless communication device of the fourteenth embodiment of the present invention of FIG. 14 is capable of reducing in size of the circuit area and modules in comparison with the thirteenth embodiment wherein the modulator and demodulator are formed in different modules by providing three modules of the first module mainly constituted with: a modulator, demodulator and local oscillator; the second module mainly constituted with filter and duplexer, and the third module mainly constituted with power amplifier, as the modules constituting the front-end unit and modulator/demodulator unit.

### Fifteenth Embodiment

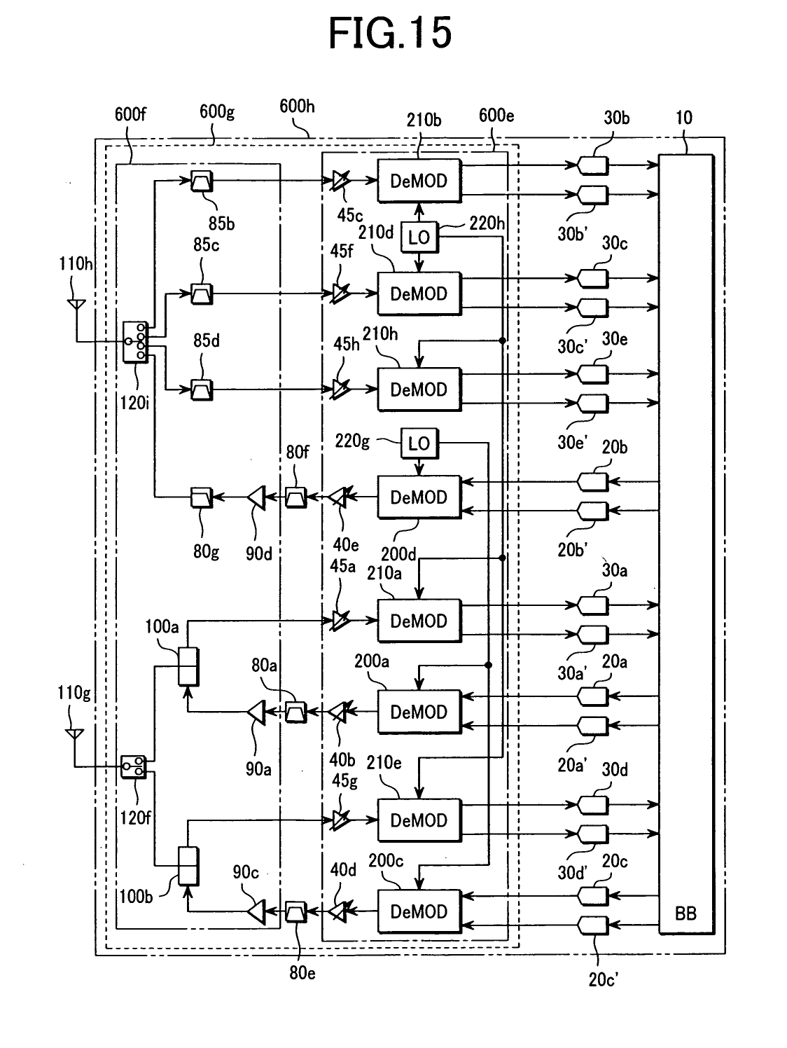

FIG. 15 is a block diagram showing a module structure of a radio frequency circuit unit of a cellular phone terminal provided with the multi-band multi-mode wireless communication device as the fifteenth embodiment of the present invention. First, with reference to FIG. 15, a structure of the multi-band multi-mode wireless communication device of the fifteenth embodiment of the present invention will be explained.

In FIG. 15, 600f denotes a profile of module constituted with modules 600a and 600b. 600g denotes a profile of module constituted with modules 600e and 600f and filters 80a, 80e and 80f. 600h denotes a profile of module constituted with module 600g, base-band signal processor 10, D/A converters 20a to 20c′, and A/D converters 30a to 30e′. Namely, the front-end unit, modulator/demodulator unit and base-band unit are formed as the integrated module as the module 600h.

Principal effects of the receiver circuit block of the multi-band multi-mode wireless communication device of the fifteenth embodiment of the present invention of FIG. 15 are as follows.

The multi-band multi-mode wireless communication device of the fifteenth embodiment of the present invention of FIG. 15, in comparison with the fourteenth embodiment where the modulator and demodulator are formed in different modules, is capable of reducing the size of circuit area and module by comprising two modules in which the first module is mainly constituted with filter, duplexer, and power amplifier and the second module is mainly constituted with modulator, demodulator, and local oscillator. Moreover, the cellular phone terminal provided with the multi-band multi-mode wireless communication device of the fifteenth embodiment of the present invention can be designed easily because component structure of the radio frequency circuit unit is simplified.

In addition, since the power amplifier and filter or duplexer are formed in the same module, circuit design can be made thoroughly for the power amplifier and filter or power amplifier and duplexer and thereby reduction in size and power consumption of circuit area may be obtained.

Moreover, the multi-band multi-mode wireless communication device of the fifteenth embodiment of the present invention is capable of reducing the size of the circuit area and module, in comparison with the other module profiles, by realizing the same with only one module, namely by forming as the integrated module with inclusion of the module constituting the base-band unit in addition to the module constituting the front-end unit and modulator/demodulator unit. In addition, the cellular phone terminal can be designed easily because the same cellular phone terminal provided with the multi-band multi-mode wireless communication device of the fifteenth embodiment of the present invention can be simplified in the component structure of the radio frequency circuit unit.

### Sixteenth Embodiment

The multi-band multi-mode wireless communication device of the respective embodiments of the present invention explained above is also may be embodied by changing the peripheral circuits thereof.

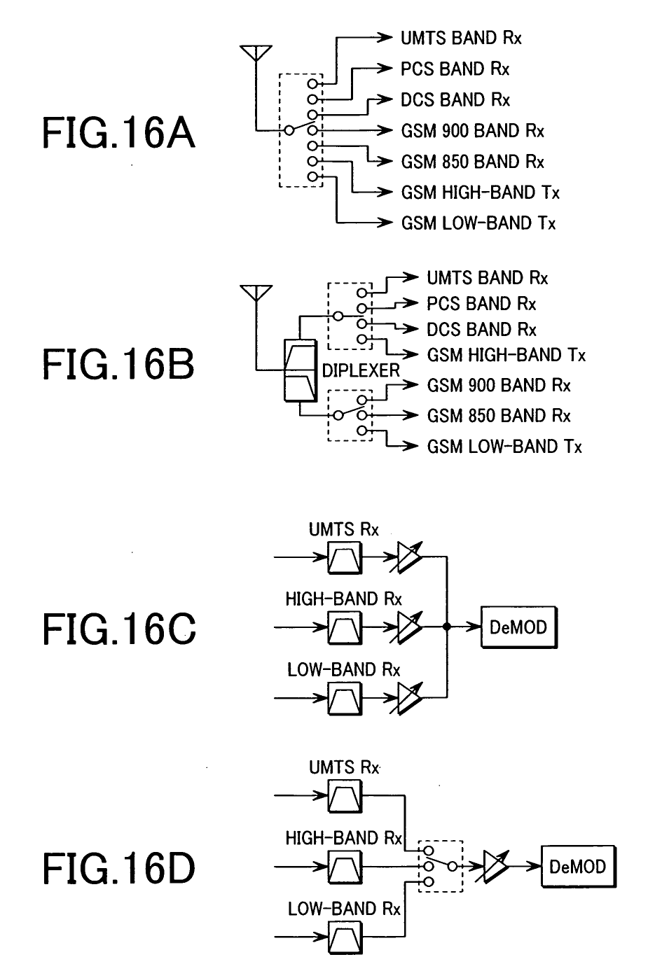

FIG. 16 is diagram showing modification examples of a peripheral circuit in each embodiment of the present invention.

For example, a multi-band multi-mode wireless communication device including seven transmitting and receiving paths can also be constituted by using, as shown (a) in FIG. 16, one SP7T switch in place of the SP3T switch as the antenna switch.

Moreover, as shown (b) in FIG. 16, a multi-band multi-mode wireless communication device including seven transmitting and receiving paths can also be constituted using also the diplexer, SP3T switch and SP4T switch as the antenna switch.

In addition, as shown (c) in FIG. 16, the multi-band multi-mode wireless communication device individually allocating a band-pass filter (BPF) and a low-noise amplifier (LNA) can also be constituted. Or, as shown (d) in FIG. 16, the multi-band multi-mode wireless communication device using in common the low-noise amplifier (LNA) and a filter band of the band-pass filter (BPF) can also be constituted.

### Seventeenth Embodiment

An example of the cellular phone terminal has been explained above as a circuit provided with the multi-band multi-mode wireless communication device as an embodiment of the present invention. However, the multi-band multi-mode wireless communication device as an embodiment of the present invention can also be applied to a PDA and the other mobile communication terminals, in addition to a cellular phone terminal.

Moreover, the cellular phone terminal corresponding to the single-band GSM and single-band W-CDMA has been explained in the first to fourth embodiments, while the cellular phone terminal corresponding to the single-band GSM and dual-band W-CDMA, in the fifth to ninth embodiments and the cellular phone terminal corresponding to the dual-band GSM and dual-band W-CDMA, in the ninth to sixteenth embodiments. However, the multi-band multi-mode wireless communication device as an embodiment of the present invention is not limited to the number of bands explained above and can also be applied to the wireless communication device corresponding to the desired number of bands. Moreover, the wireless communication system is not limited to the GSM and W-CDMA system and can also be applied to the desired TDD and FDD systems.

### Eighteenth Embodiment

Furthermore, two receiver circuit blocks for W-CDMA as the FDD system have been explained as a circuit structure corresponding to the diversity receiving function. However, the multi-band multi-mode wireless communication device as an embodiment of the present invention is not limited only to the diversity receiving and can also be applied to the desired wireless communication device for increasing communication capacity by synthesizing signals such as MIMO (Multi Input Multi Output) system.

The multi-band multi-mode wireless communication device of each embodiment of the present invention can provide the effect to realize reduction in size and power consumption of the receiver circuit corresponding to plural frequency bands and plural systems provided to a mobile communication terminal such as a cellular phone terminal. Moreover, the same multi-band multi-mode wireless communication device can provide the effects thereof in the mobile devices, household devices and the other devices used for wireless communication in addition to the cellular phone terminals.

What is claimed is:

1. A wireless communication device comprising:
a first receiver circuit for inputting a received signal received by a first antenna, corresponding to the frequency division duplex (FDD) system;
a second receiver circuit for inputting a received signal received by a second antenna, corresponding to the FDD system; and
a local oscillator for supplying in common the local oscillated frequency to the first and the second receiver circuits,
wherein the received signals received by the first antenna and the second antenna are synthesized with each other to be obtained as the received signal, and
wherein the first and the second receiver circuits and the local oscillator are formed in the same semiconductor device.

2. The wireless communication device according to claim 1,
wherein at least one of the first receiver circuit and the second receiver circuit uses the direct down-conversion system.

3. The wireless communication device according to claim 1,
wherein at least one of the first receiver circuit and the second receiver circuit uses the low IF down-conversion system.

4. The wireless communication device according to claim 1,
wherein the wireless communication device corresponds to the W-CDMA.

5. The wireless communication device according to claim 1,
wherein the wireless communication device corresponds to the HSDPA system.

6. The wireless communication device according to claim 1,
wherein the wireless communication device corresponds to EV-DO system.

7. A wireless communication device by utilizing not three but two antennas for realizing a multi-band multi-mode wireless communication, the wireless communication device comprising:
a first receiver circuit applicable to a frequency division duplex communication system;
a second receiver circuit applicable to the frequency division duplex communication system; and
a third receiver circuit applicable to a wireless communication system being different from the frequency division duplex communication system.

8. The wireless communication device according to claim 7,
wherein the wireless communication system different from the wireless communication system is the time division duplex (TDD) system.

9. The wireless communication device according to claim 7,
wherein the wireless communication device includes local oscillators for supplying local frequency to the first and the second receiver circuits, and
wherein the first receiver circuit, the second receiver circuit, the third receiver circuit, and the local oscillator are formed in the same semiconductor device.

10. The wireless communication device according to claim 7,
wherein the wireless communication device is a multi-band multi-mode wireless communication device corresponding to the single-band GSM and single-band W-CDMA.

11. The wireless communication device according to claim 7, further comprising:
a first antenna;
a second antenna;
a first transmitter circuit and a first receiver circuit corresponding to the FDD system;
a second transmitter circuit and a third receiver circuit corresponding to the TDD system;
a duplexer;
one SP3T switch; and
a base-band signal processor,
wherein the first antenna, the first transmitter circuit, and the first receiver circuit are connected via the duplexer,
wherein the second antenna, the second transmitter circuit, the second receiver circuit, and the third receiver circuit are connected via the SP3T switch, and
wherein the received signals corresponding to the FDD system received by the first and second antennas are input to the base-band signal processor via the first and second receiver circuits to synthesize these signals in the base-band signal processor.

12. The wireless communication device according to claim 7, further comprising:
a second antenna;
a third antenna;
a first transmitter circuit and a first receiver circuit corresponding to the FDD system;
a second receiver circuit corresponding to the FDD system;
a second transmitter circuit and a third receiver circuit corresponding to the TDD system;
a duplexer;
an SP3T switch; and
a base-band signal processor,
wherein the second antenna and the second receiver circuit are connected,
wherein the second transmitter circuit, the third receiver circuit and the duplexer are connected via the third antenna and the SP3T switch,
wherein the duplexer is connected to the first transmitter circuit and the first receiver circuit, and
wherein the received signals corresponding to the FDD system received by the first and second antennas are input to the base-band signal processor via the first and second receiver circuits to synthesize these signals in the base-band signal processor.

13. The wireless communication device according to claim 7,
wherein the wireless communication device uses both frequency bands of a first frequency band and a second frequency band being different from the first frequency band each as at least one of a transmission frequency band and a reception frequency band,
wherein one of a plurality of receiver circuit blocks each including a variable gain amplifier and a modulator is applicable to both W-CDMA and GSM, said W-CDMA using the second frequency band and belonging to the frequency division duplex communication system, and said GSM using the second frequency hand and belonging to the wireless communication system being different from the frequency division duplex communication system, and
wherein another receiver circuit block including a variable gain amplifier and a modulator than the plurality of receiver circuit blocks is applicable to both W-CDMAs using the first frequency band and using the second frequency band, respectively.

14. The wireless communication device according to claim 13,
wherein a filter and the variable gain amplifier is used in common for GSM and W-CDMA in the second frequency band and individual demodulators are used for the GSM and W-CDMA as the demodulators.

15. The wireless communication device according to claim 13,
wherein the D/A converter and A/D converter are used in common for the W-CDMA using the first frequency band and the W-CDMA using the second frequency band.

16. The wireless communication device according to claim 13, further comprising:
a wireless communication device having the diversity receiving function comprising a pair of transmitter/receiver circuit block and receiver circuit block for the W-CDMA using the first frequency band;
a wireless communication device having the diversity receiving function comprising a pair of transmitter/receiver circuit block and receiver circuit block for the W-CDMA using the second frequency band;
a transmitter circuit block for the GSM using the second frequency band and a third frequency band being different from each of the first and second frequency bands;
a receiver circuit block for the GSM using the second frequency band; and
another receiver circuit block for the GSM using the third frequency band than the receiver circuit block for the GSM using the second frequency band.

17. A cellular phone terminal comprising:
two antennas;
a first receiver circuit and a second receiver circuit corresponding to the FDD system;
a third receiver circuit for wireless communication system different from the FDD system;
a switch for changing over the connecting state between the two antennas and the receiver circuit; and
a base-band signal processor,
wherein the base-band signal processor has the function to control switching of the switch in accordance with the communication system.

18. A cellular phone terminal according to claim 17, further comprising:
a front-end unit;
a demodulator; and
a base-band signal processor,
wherein the front-end unit includes a passive component module mainly comprising a filter and a duplexer, and a power amplifier module mainly constituted with power amplifier,
wherein the modulator/demodulator unit includes a modulator/demodulator module mainly comprising a modulator, a demodulator, and a local oscillator, and
wherein the front-end unit and the modulator/demodulator unit are formed on an integrated module.

19. The cellular phone terminal according to claim 17,
wherein the base-band signal processor has the function to synthesize the received signals corresponding to the FDD system received by the two antennas.

20. The cellular phone terminal according to claim 17, further comprising:
a passive component module;
a power amplifier module;
a modulator module;
a demodulator module; and
a base-band signal processor,
wherein the passive component module, the power amplifier module, the modulator module, the demodulator module, and the base-band signal processor are formed on the integrated module.
